(19) United States
(12) Patent Application Publication
(10) Pub. No.: US 2025/0242366 A1
(43) Pub. Date: Jul. 31, 2025

(54) POWERED SPRAY DISPENSER

(71) Applicant: The Procter & Gamble Company, Cincinnati, OH (US)

(72) Inventors: Cody Dylan Lewis, Lawrenceburg, IN (US); Matthew Stephen Bauer, Loveland, OH (US); Su Yon Chang, Mason, OH (US); Richard Lee Lane, Cincinnati, OH (US)

(21) Appl. No.: 19/041,250

(22) Filed: Jan. 30, 2025

Related U.S. Application Data
(60) Provisional application No. 63/626,576, filed on Jan. 30, 2024.

(51) Int. Cl. B05B 9/04

(52) U.S. Cl. CPC B05B 9/0426; B05B 9/0413

(57) ABSTRACT

A spray dispenser container includes a housing having a first end portion, a second end portion, a sidewall extending between the first end portion and the second end portion, and a cavity at least partially surrounded by the sidewall; a pump assembly in fluid communication with a replaceable composition container including a composition, the pump assembly being disposed within the cavity; an actuator in operative communication with the pump assembly; a nozzle in fluid communication with the pump assembly; and a motor in operative communication with the actuator. Furthermore, when the spray dispenser container is rotated 360° along the vertical plane, the pump assembly maintains fluid communication with the replaceable composition container such that the composition can be dispensed throughout the 360° rotation.

### TECHNICAL FIELD

The present disclosure is related to a powered spray dispenser.

### BACKGROUND

Conventional sprayer dispensers are considered single use by many consumers and do not deliver optimal performance. Manufacturers have designed them generically to dispense a myriad of fluids so that they can be mass produced and utilized for a wide range of dispensing purposes and categories. By being generically designed, conventional sprayers are very limited in their ability to be adjusted in dispensing characteristics. Often the only variability is between streaming, foaming, or misting using a physical dial at the nozzle. Additionally, conventional sprayers have suboptimal particle size distribution (such as a particle size Dv10 ranging from 40 to 80 microns; a particle size Dv50 ranging from 90 to 150 microns; and a particle size Dv90 ranging from 150 to 400 microns), dripping, and requiring greater force to actuate the trigger are common amongst today's single use sprayers. Additionally, conventional sprayers must be thrown away and end up in landfill due to mixed materials which cannot be introduced to a single recycle stream. Further, conventional refillable sprayer dispensers are often messy during the refill experience. These refillable sprayers do not offer mechanisms to enable optimized spray for various compositions. Additionally, conventional powered spray dispensers rely on traditional dip tubes to feed the fluid to the pump. This configuration restricts the directional range consumers can dispense the product effectively and evenly. Additionally, traditional sprayers require a coupling between human hand mechanical engagement and actuation, regardless of the complexity/physical nature of the job. For example, waving a sprayer while trying to coat a large surface, articulating the targeting of the nozzle, and dialing up/down spray performance based on proximity.

All of these job adjustments are compromised by muscle tiring, limitations of human mechanics, and the senses such as eyesight. Therefore, a need exists for an improved powered refillable sprayer dispenser.

### SUMMARY

According to a first example of the present disclosure, a spray dispenser container includes a housing having a first end portion, a second end portion, a sidewall extending between the first end portion and the second end portion, and a cavity at least partially surrounded by the sidewall; a pump assembly in fluid communication with a replaceable composition container including a composition, the pump assembly being disposed within the cavity; an actuator in operative communication with the pump assembly; a nozzle in fluid communication with the pump assembly; and a motor in operative communication with the actuator. Furthermore, when the spray dispenser container is rotated 360° along the vertical plane, the pump assembly maintains fluid communication with the replaceable composition container such that the composition can be dispensed throughout the 360° rotation.

In accordance with another example of the present disclosure, a replaceable fluid composition container includes a sidewall including a flexible inner liner. The sidewall partially surrounds a reservoir comprising a composition. The replaceable fluid composition container further includes a puncturable cap connected to the sidewall and the puncturable cap includes a frangible seal.

### BRIEF DESCRIPTION OF THE DRAWINGS

FIG. 1 is a perspective view of a spray dispenser, in accordance with examples of the present disclosure.

FIG. 2 is a cut-away view of a spray dispenser, in accordance with examples of the present disclosure.

FIG. 3 is an exploded view of a spray dispenser, in accordance with examples of the present disclosure.

FIG. 4 is a perspective view of a replaceable composition container, in accordance with examples of the present disclosure.

FIGS. 5A and 5B are cutaway views of a replaceable composition container, in accordance with examples of the present disclosure, at different fill levels.

### DETAILED DESCRIPTION

The present disclosure may be understood more readily by reference to the following detailed description of illustrative and preferred examples. It is to be understood that the scope of the claims is not limited to the specific products, methods, conditions, devices, or parameters described herein, and that the terminology used herein is not intended to be limiting of the claimed examples of the disclosure.

Also, as used in the specification, including the appended claims, the singular forms “a,” “an,” and “the” include the plural, and reference to a particular numerical value includes at least that particular value, unless the context clearly dictates otherwise. When a range of values is expressed, another example includes from the one particular value and/or to the other particular value. Similarly, when values are expressed as approximations, by use of the antecedent basis “about,” it will be understood that the particular values form another example. All ranges are inclusive and combinable. All percentages and ratios used herein are by weight of the total product, and all measurements made are at 21° C., unless otherwise designated.

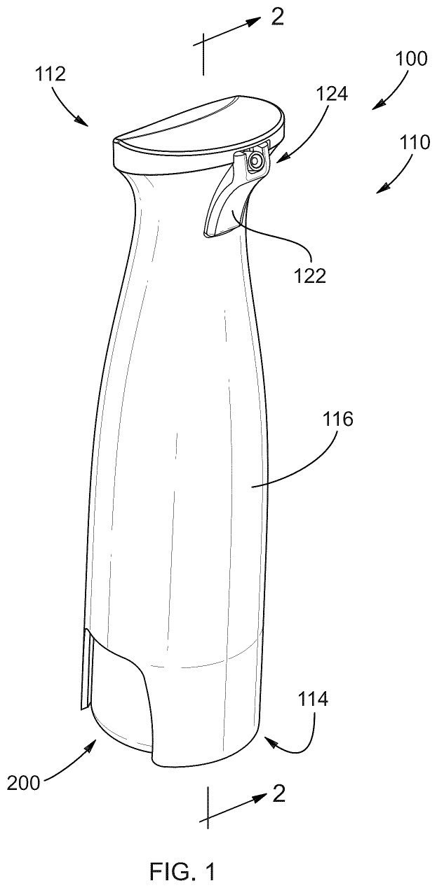

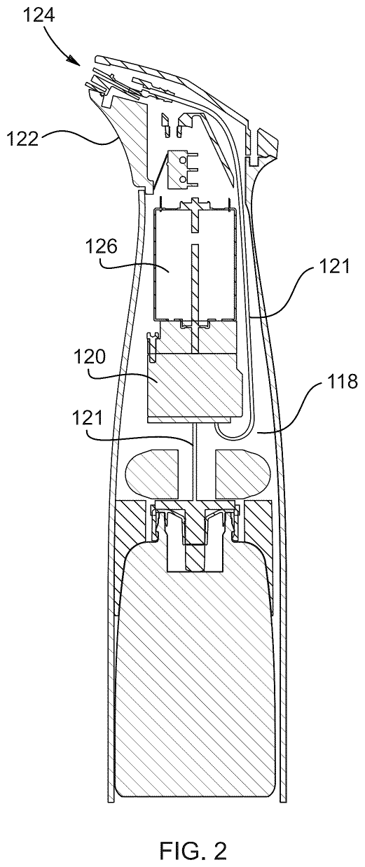

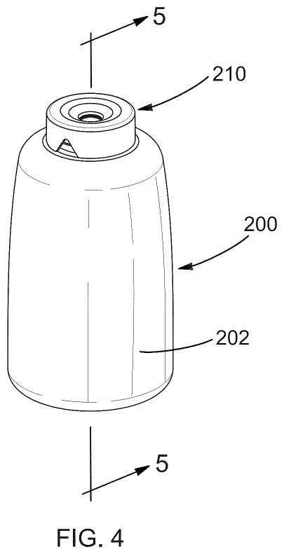

Referring initially to FIGS. 1-5, a spray dispenser container 100 in accordance with examples of the present disclosure may include a housing 110, a pump assembly 120, an actuator 122, a nozzle 124, and a motor 126. In examples, the spray dispenser container 100 may include a replaceable composition container 200. The replaceable composition container 200 may include a composition 208. When the spray dispenser container is rotated 360° along the vertical plane, the pump assembly 120 may maintain fluid communication with the replaceable composition container 200 such that the composition 208 can be dispensed throughout the 360° rotation.

The housing 110 may include a first end portion 112 and a second end portion 114. The housing 110 may further have a sidewall 116 extending between the first end portion 112 and the second end portion 114. The housing 110 may further define a cavity 118 at least partially surrounded by the sidewall 116. The housing 110 may taper to a neck disposed between the first end portion 112 and the second end portion 114. The reduced perimeter of the neck may facilitate gripping of the housing 110 by the user. The reduced perimeter of the neck in combination with the required location for the pump assembly created narrow points for the flow path to pass. In examples, semi-rigid tubing and relief channels in the outer housing may be used to mitigate these challenges. In examples, the flow path 121 may be made an integral component of the housing 110.

The housing 110 may be comprised of various materials including metal or plastic. The housing 110 may include polyethylene terephthalate (PET), polyethylene furanoate (PEF), polyester, nylon, polyolefin, ethylene vinyl alcohol (EVOH), or mixtures thereof. The container may be a single layer or multi-layered. The housing 110 may be injection molded or blow molded, such as in an injection-stretch blow molding process or an extrusion blow molding process. The container may be rigid or flexible.

The pump assembly 120 may be disposed within the cavity 118. The pump assembly 120 may be in fluid communication with the replaceable composition container 200. In examples, the pump assembly 120 may include a variable pressure diaphragm pump or a variable pressure gear pump. Variable pressure pumps enable the device to change the spray performance based on consumer input, sensor input, or environmental conditions. All can be used to help deliver preferred spray performance. Variable pressure is desirable because there is a direct relationship between pressure, flow rate, and atomization characteristics such as particle size distribution, cone angle, cone velocity gradient, and atomization sound.

The nozzle 124 may be in fluid communication with the pump assembly 120. In examples, the spray dispenser container 100 dispenses a fine mist of composition 208 through the nozzle 124. A fine mist may include particle size distributions have a Dv10 ranging from 1 to 40 microns, a Dv50 ranging from 50 to 80 microns, and a Dv90 ranging from 90 to 160 microns, and any values within the foregoing ranges or any ranges created thereby. A fine mist may include a Sauter Mean of less than 130 microns, a Sauter Mean of from 20 to 130 microns, or any values within the foregoing ranges or any ranges created thereby. In examples, the flow rate of the composition 208 exiting the nozzle may range from 0.5 to 5 milliliters per second (ml/s), from 0.5 to 4.5 ml/s, from 0.5 to 4 ml/s, from 0.5 to 3.5 ml/s, from 0.5 to 3 ml/s, from 0.5 to 2.5 ml/s, from 0.5 to 2 ml/s, from 0.5 to 1.5 ml/s, from 0.5 to 1 ml/s, from 1 to 5 ml/s, from 1 to 4.5 ml/s, from 1 to 4 ml/s, from 1 to 3.5 ml/s, from 1 to 3 ml/s, from 1 to 2.5 ml/s, from 1 to 2 ml/s, from 1 to 1.5 ml/s, from 1.5 to 5 ml/s, from 1.5 to 4.5 ml/s, from 1.5 to 4 ml/s, from 1.5 to 3.5 ml/s, from 1.5 to 3 ml/s, from 1.5 to 2.5 ml/s, from 1.5 to 2 ml/s, from 2 to 5 ml/s, from 2 to 4.5 ml/s, from 2 to 4 ml/s, from 2 to 3.5 ml/s, from 2 to 3 ml/s, from 2 to 2.5 ml/s, from 2.5 to 5 ml/s, from 2.5 to 4.5 ml/s, from 2.5 to 4 ml/s, from 2.5 to 3.5 ml/s, from 2.5 to 3 ml/s, from 3 to 5 ml/s, from 3 to 4.5 ml/s, from 3 to 4 ml/s, from 3 to 3.5 ml/s, from 3.5 to 5 ml/s, from 3.5 to 4.5 ml/s, from 3.5 to 4 ml/s, from 4 to 5 ml/s, from 4 to 4.5 ml/s, from 4.5 to 5 ml/s, or any values within the foregoing ranges or any ranges created thereby.

In examples, the spray dispenser container 100 may further include a valve assembly (not shown). The valve assembly would be incorporated in the flow path to only allow fluid flow in one direction, towards the nozzle. This ensures fluid does not travel back into the composition container and maintains priming of the fluid flow path. A first valve may prevent reverse directional flow of the composition 208. A second valve may reduce the cross-sectional area dynamically by restricting the flow path geometrically, and/or would variably change the pressure needed to open a path aperture.

Referring now to FIGS. 1, 4, and 5, as previously described, the spray dispenser container 100 may further include a replaceable composition container 200. The replaceable composition container 200 may include a sidewall 202 and a puncturable cap 210.

The replaceable composition container 200 may include recyclable content. The replaceable composition container 200 may include from 80% to 100%, from 80% to 99%, from 80% to 98%, from 80% to 97%, from 80% to 95%, from 80% to 90%, from 80% to 85%, from 85% to 100%, from 85% to 99%, from 85% to 98%, from 85% to 97%, from 85% to 95%, from 85% to 90%, from 90% to 100%, from 90% to 99%, from 90% to 98%, from 90% to 97%, from 90% to 95%, from 95% to 100%, from 95% to 99%, from 95% to 98%, from 95% to 97%, from 97% to 100%, from 97% to 99%, from 97% to 98%, from 98% to 100%, from 98% to 99%, from 99% to 100%, or any values within the foregoing ranges or any ranges created thereby, of recyclable content.

The replaceable composition container 200 may include plastic, such as polyethylene (PE), low density polyethylene (LDPE), high density polyethylene (HDPE), polypropylene (PP), polystyrene (PS), polyvinyl chloride (PVC), flexible ionomers, ethylene vinyl alcohol (EVOH), or combinations thereof. The replaceable composition container 200 may include from 20 to 50 wt. %, from 20 to 45 wt. %, from 20 to 40 wt. %, from 20 to 35 wt. %, from 20 to 30 wt. %, from 20 to 25 wt. %, from 25 to 50 wt. %, from 25 to 45 wt. %, from 25 to 40 wt. %, from 25 to 35 wt. %, from 25 to 30 wt. %, from 30 to 50 wt. %, from 30 to 45 wt. %, from 30 to 40 wt. %, from 30 to 35 wt. %, from 35 to 50 wt. %, from 35 to 45 wt. %, from 35 to 40 wt. %, from 40 to 50 wt. %, from 40 to 45 wt. %, from 45 to 50 wt. %, or any values within the foregoing ranges or any ranges created thereby, of plastic by weight of the replaceable composition container 200.

The replaceable composition container 200 may include fiber-based material. The fiber-based material may include recycled content, such as newspaper and/or cardboard, and/or natural fibers. The natural fibers may include wood pulp, bamboo, bagasse, wheat straw, and combinations thereof. The replaceable composition container 200 may include from 50 to 80 wt. %, from 50 to 75 wt. %, from 50 to 70 wt. %, from 50 to 65 wt. %, from 50 to 60 wt. %, from 50 to 55 wt. %, from 55 to 80 wt. %, from 55 to 75 wt. %, from 55 to 70 wt. %, from 55 to 65 wt. %, from 55 to 60 wt. %, from 60 to 80 wt. %, from 60 to 75 wt. %, from 60 to 70 wt. %, from 60 to 65 wt. %, from 65 to 80 wt. %, from 65 to 75 wt. %, from 65 to 70 wt. %, from 70 to 80 wt. %, from 70 to 75 wt. %, from 75 to 80 wt. %, or any values within the foregoing ranges or any ranges created thereby, of fiber-based material by weight of the replaceable composition container 200.

The puncturable cap 210 may be connected to the sidewall 202. In examples, the puncturable cap 210 may include a frangible seal 212. The frangible seal 212 may be made of LDPE, PP, HDPE, PE, or microporous membrane. The frangible seal 212 can be an elastomeric membrane. The frangible seal 212 can be silicone or even a single layer of silicone. Optionally, the frangible seal 212 can be a laminate of silicone and polyethylene terephthalate. The surface of the frangible seal 212 oriented towards a reservoir 206 of the replaceable composition container 200 can be polyethylene terephthalate so as to provide for chemical compatibility between the frangible seal 212 and the contents of the replaceable composition container 200. The frangible seal 212 can be an elastomeric membrane. The frangible seal 212 can have a thickness less than 5 mm, optionally less than 3 mm, optionally less than 2 mm, optionally less than 1 mm. The frangible seal 212 can have a shape that can cover open surface of the replaceable composition container 200. The frangible seal 212 can have a circular shape and the open surface of the container 200 can be a circular annulus likewise. The frangible seal 212 can be joined to a sealing surface of the open surface of the container 200 by heat sealing, gluing, welding, or other technique, by way of nonlimiting example.

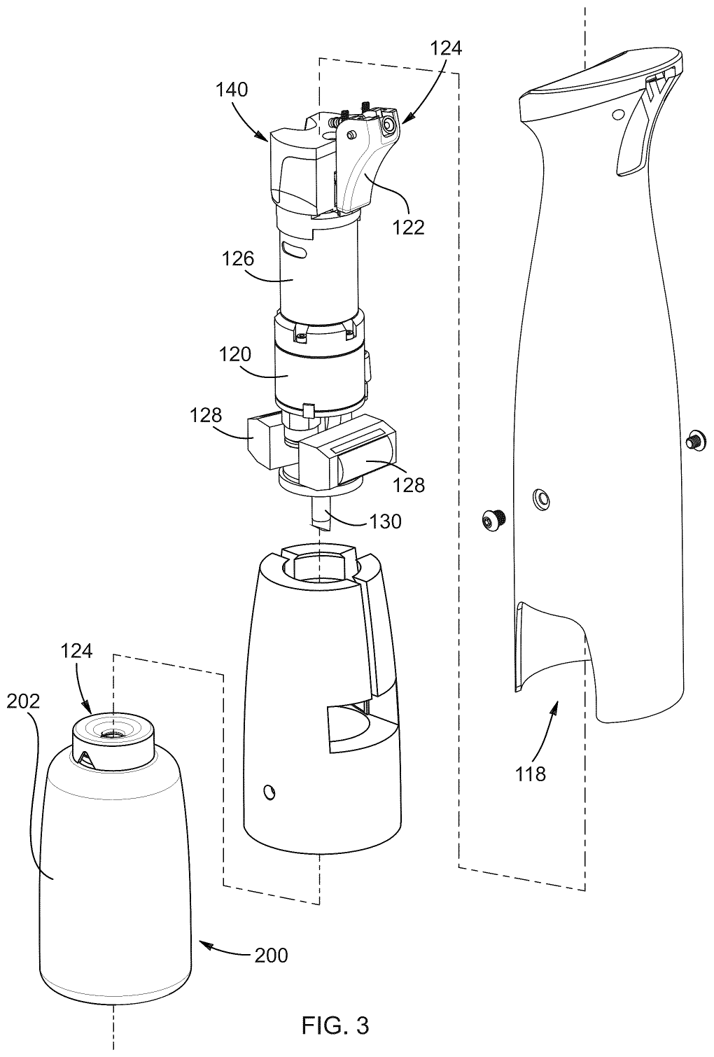

In examples, the puncturable cap 210 may click when activated. The puncturable cap 210 is activated when the replaceable composition container 200 is put into the spray dispenser container 100 as shown in FIG. 1. Specifically, the pierce mechanism 130 of the spray dispenser container 100, as shown in FIG. 3, pierces the frangible seal 212 in the puncturable cap 210, and the replaceable composition container 200 clicks into place. In examples, the replaceable composition container 200 is held in place by means of friction between the pierce mechanism 130 and the puncturable cap 210. In examples, the replaceable composition container 200 may be held in place via a barb feature located on the pierce mechanism 130. In examples, the replaceable composition container 200 may be held in place via a barb feature located about the closure of the replaceable composition container 200. In examples, the replaceable composition container 200 may be held in place via a torque-based mechanism with a lug that prevents reverse rotation or a lever that squeezes about the replaceable composition container 200 as it is inserted into the spray dispenser container 100. In examples, the replaceable composition container 200 may include threads along the opening of the replaceable composition container (not shown) to allow a screw in mechanism to the spray dispenser container 100.

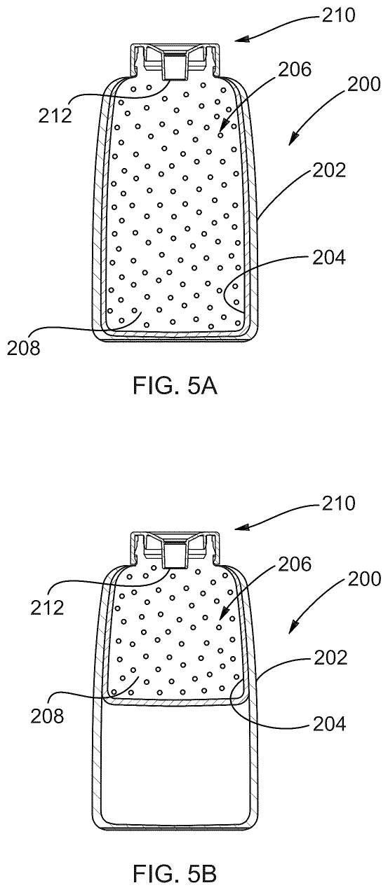

In examples, the replaceable composition container 200 may include a delaminating bottle. As shown in FIGS. 5A and 5B, the sidewall 202 may include a flexible inner liner 204. The flexible inner liner 204 may be made of LDPE, EVOH, PP, or combinations thereof.

The sidewall 202 may partially surround a reservoir 206. The reservoir 206 may include a composition 208.

The spray dispenser container is configured to accommodate a replaceable composition container in the spray dispenser container cavity through an annular opening located at the base of the spray dispenser container sidewall. This annular opening serves dual purposes: acting as the interface for charging and providing a stable base when the spray dispenser container is rested on a surface. Upon insertion, the replaceable composition container is positioned either flush or slightly recessed above the bottom edge of the sidewall, which may otherwise limit user access for removal. To address this, strategically positioned cutouts are provided in the sidewall around the circumference of the annular opening. These cutouts are optimized to allow the user to easily grip the sides of the replaceable composition container for removal while minimizing the risk of accidental dislodgement during regular use.

The retention mechanism for the replaceable composition container is located at various points around the annular housing where no cutouts are present, or further into the cavity 118, either at the interface between the replaceable composition container neck and the housing or within the piercer-to-container cap interface. These retention points ensure secure positioning of the replaceable composition container during operation. Additionally, the cutouts are designed with a sufficient height, ranging from approximately 10% to 40% of the replaceable composition container's height, to allow visual monitoring of the replaceable composition container's fill level. This is achieved by enabling incident light to penetrate the transparent surface of the replaceable composition container, facilitating clear observation of the collapse state of the flexible inner liner when present, and thereby providing a reliable indication of the replaceable composition container's remaining content.

Referring now to FIGS. 1-5, the spray dispenser container 100 may further include a flow path 121 from the replaceable composition container 200 through the pump assembly 120 to the nozzle 124. In operation, when the pump assembly 120 pulls a vacuum on the replaceable composition container 200 and pumps the composition 208 through the flow path 121 from the replaceable composition container 200 through the pump assembly 120 to the nozzle 124, it is contemplated that the reduction of composition 208 inside the reservoir 206 will cause a vacuum phenomenon wherein the flexible inner liner 204 delaminates from the sidewall 202 (as shown in FIG. 5B), thereby allowing the composition 208 to continuously be in contact with the pierce mechanism 130 and therefore maintaining continuous composition 208 flow through the flow path 121 in any orientation.

In examples, the spray dispenser 100 may create a vacuum within the replaceable composition container 200 to extract the composition 208 onto the flow path 121. Once in the flow path 121, the pump assembly 120 may pressurize the composition 208 to from 2 to 10 bar, from 2 to 8 bar, from 2 to 6 bar, from 2 to 4 bar, from 4 to 10 bar, from 4 to 8 bar, from 4 to 6 bar, from 6 to 10 bar, from 6 to 8 bar, from 8 to 10 bar, or any values within the foregoing ranges or any ranges created thereby.

The actuator 122 may be in operative communication with the pump assembly 120 and the motor 126. Pressing the actuator 122 may put the nozzle 124 into fluid communication with the composition 208 through the flow path 121. Pressing the actuator 122 may actuate the pump assembly 120 and the motor 126 to pressurize the composition 208 to move the composition 208 along the flow path 121 to the nozzle 124.

Referring now to the spray dispenser container, the pump assembly is strategically located neither in the head portion of the spray dispenser container (i.e., above the hand) nor in the lower region near the composition container (i.e., below the hand). Rather, the pump assembly is positioned to help ensure that the center of mass of the spray dispenser container remains balanced across various fill levels of the composition container. From an ergonomic perspective, this configuration minimizes the shifting of the center of mass, which would otherwise result in significant mass displacement at the extremities of the composition container (e.g., near full or near empty), thereby causing an undesirable moment that can induce muscle strain and compromise precise targeting of the spray dispenser container.

The placement of the motor of the pump assembly within the neck further enhances the design by reducing resonant sound and vibration. This is achieved through the structural rigidity and natural dampening provided by the user's hand when gripping the spray dispenser container. The ergonomic benefits of this arrangement not only improve user comfort but also contribute to a quieter and more controlled operation of the spray dispenser container.

This design presents specific challenges given the inherent diameter constraints of both the motor and pump assembly, requiring careful routing of the flow path to pass through the same spatial constraints while minimizing the overall width of the neck or grip area encasing the pump assembly. Accordingly, careful selection and design of the pump assembly orientation relative to both the flow path axis and the pump axis have been conducted to achieve an ergonomically favorable and mechanically efficient configuration.

The spray dispenser container 100 may further include a battery 128. The spray dispenser container 100 may include 1 to 5 batteries, 1 to 3 batteries, 1 battery, 2 batteries (as shown), or 3 batteries. In examples, the battery 128 may be rechargeable. The battery may provide the electrical power to operate the pump assembly 120, the actuator 122, the motor 126, and the microprocessor 140.

In some examples where the spray dispenser container includes a rechargeable battery, the spray dispenser container may include a user access panel for the removal or insertion of batteries. In some other examples where the spray dispenser container includes a rechargeable battery, the annular opening located at the base of the spray dispenser container sidewall and/or surrounding region may serve as a charging interface for the spray dispenser container. The absence of such a user access panel enhances the overall design by improving the aesthetics and ergonomics of the grip surface, while also reducing the likelihood of fluid leaks or drips infiltrating the internal electronic components of the device. To facilitate charging, provision for charging contacts may be incorporated at or near the annular edge of the sidewall.

Alternatively, provision for non-contact charging, such as inductive charging coils, may be included. This non-contact approach further mitigates the risk of device failure due to corrosion when exposed to wet surfaces at the base of the device. In such an embodiment, the placement of the charging coil presents a design consideration due to the balance between positioning the wound charging coil and accommodating the user access cutouts for the refill bottle. Therefore, the charging coil may be positioned slightly off-axis relative to the annular housing ring, or higher along the annular body, to enable charging at a sufficient distance from the mating transponder. Additionally, the coil may be integrated into a recessed charging base, allowing for efficient charging while maintaining the integrity of the device's structural design and functionality.

The provision for both contact and non-contact charging options introduces a natural design tension related to the routing of the charge-conducting wires from the charging interface to the power management system located on the printed circuit board. This challenge has been accounted for in the double-walled inner structure of the annular-shaped body of the spray dispenser container, which provides a protected pathway for the wires. The double-wall design not only preserves the ergonomic and aesthetic aspects of the spray dispenser container but also ensures the safe and efficient transmission of power without compromising the internal electronics or structural integrity of the spray dispenser container.

The spray dispenser container 100 may further include a microprocessor 140. The microprocessor 140 may include any processing component operable to receive and execute instructions. The microprocessor may contain or interface with a memory. The microprocessor may be containing or interfacing with a transponder to communicate device data for tuning, behavioral observation, or coaching/replenishment such as disclosed in EP3513927B1, U.S. Ser. No. 10/298,471B2, US20170097758A1 which are hereby incorporated by reference. The microprocessor 140 may include and/or be configured to interface with the pump assembly 120, the actuator 122, the battery 128, and any sensors included in the spray dispenser container 100 (such as a proximity sensor or a motion sensor as hereinafter described), and/or other device for receiving, sending, and/or presenting data. From this connection, communication may be facilitated between communicatively coupled features such as the pump assembly 120, the actuator 122, the battery 128, and any sensors included in the spray dispenser container 100.

The spray dispenser container 100 may further include a proximity sensor (not shown). In examples where the spray dispenser container 100 includes a proximity sensor, the spray dispenser container 100 may further include a proximity light (not shown). The proximity sensor and the proximity light may be communicably coupled to the microprocessor 140. The proximity light may indicate when the spray dispenser container 100 is too close to an object to spray effectively. For example, and not by way of limitation, the proximity light may be red or orange if the nozzle 124 of the spray dispenser container 100 is less than 20 centimeters (cm) from an object. If the spray dispenser container 100 is less than 20 cm from an object, it is contemplated that when the composition 208 is meant to aerosolize (such as when the composition 208 is a volatile composition), the composition 208 may not aerosolize into the air appropriately and instead may coalesce into liquid droplets on the object. Therefore, the proximity light may indicate to the user that the spray dispenser container 100 is not at an appropriate distance (such as greater than 20 cm from an object) to effectively operate. Additionally or alternatively, the proximity light may indicate to the user that the spray dispenser container 100 is at an appropriate distance from any nearby objects (such as greater than 20 cm from an object), and the proximity light may be yellow or green. In examples, the proximity light may change in intensity varying based on the distance of the nozzle from an object. For example, the proximity light may have a greater intensity when closer to an object (less than 20 cm) and a lesser intensity when farther from the object (greater than 20 cm), or vice versa.

In examples, the replaceable composition container 200 may further include an RFID tag, printed memory dots, or both. In examples where the replaceable composition container 200 includes an RFID tag, the microprocessor 140 may read the RFID tag and change the distance required by the proximity sensor. The distance required by the proximity sensor may be different for different compositions 208. For example, and not by way of limitation, if the composition 208 is a hard surface composition, the distance required by the proximity light to turn green may be less than the distance required by the proximity sensor to turn green for an air freshening composition or a volatile composition. Other readable features on the composition containers 200 may include ridges and/or grooves, upon which a mechanical switch may detect the ridges and/or grooves and provide a signal to the microcontroller regarding the nature of the composition within the composition container.

It is also contemplated that in such configurations where the spray dispenser recognizes the composition container therein, the microcontroller may control the pump speed. For example, if the composition container comprises an air freshening composition, the pump speed may be increased to ensure that the composition aerosolizes adequately. In contrast, where the composition container comprises a hard surface cleaner, the pump speed may be reduced to ensure that the size of the particles being emitted is larger than that of an air freshening composition.

The spray dispenser container 100 may further include a motion sensor. The motion sensor may differentiate between waving the spray dispenser container 100 or pointing the spray dispenser container 100. In examples, the motion sensor may be communicatively coupled to the microprocessor 140.

As noted, the spray dispenser container of the present disclosure can utilize different composition containers. Accordingly, the spay dispenser of the present disclosure provides much in the way of flexibility to the user in that the user may select a myriad of compositions and have them dispensed from the spray dispenser container described herein. Some suitable examples of compositions that may be dispensed via the spray dispenser are air freshening fragrances, antimicrobial sprays, insect repellents, fabric scent sprays, dishwashing liquid sprays, dishwashing detergents, and the like.

Because the spray dispenser container of the present disclosure can accommodate a variety of different compositions with vastly different chemistries in many instances, it may be beneficial such that the microcontroller is configured to evacuate the pump inlet and pump outlet to ensure that mixing of one composition with a subsequent composition is minimized. For example, the microcontroller may energize the pump subsequent to the removal of a composition container to evacuate the pump inlet/outlet.

### Air Freshening Composition 208

As previously described, the replaceable composition container 200 may include a composition 208. The composition may be a liquid composition. The composition may be a volatile composition. The composition may be an air freshening and/or fabric freshening composition, a hard surface composition, a dish composition, an insect repellant composition, a disinfecting composition, a hair care composition, a body care composition, an antiperspirant or deodorant or the like. The composition may be an air and/or fabric freshening composition.

The composition may include a perfume mixture comprising at least one perfume raw materials (PRMs). Various PRMs may be used. The composition may include a perfume mixture comprising one or more of the following perfume raw materials. As used herein, a “perfume raw material” refers to one or more of the following ingredients: fragrant essential oils; aroma compounds; pro-perfumes; materials supplied with the fragrant essential oils, aroma compounds, and/or pro-perfumes, including stabilizers, diluents, processing agents, and contaminants; and any material that commonly accompanies fragrant essential oils, aroma compounds, and/or pro-perfumes.

The PRM may include one or more ketones. The PRM comprising ketone can comprise any PRMs which contain one or more ketone moieties and which can impart a desirable scent. The PRM may comprise ketone comprising a PRM selected from the group consisting of buccoxime; iso jasmone; methyl beta naphthyl ketone; musk indanone; tonalid/musk plus; alpha-damascone, beta-damascone, delta-damascone, iso-damascone, damascenone, damarose, methyl-dihydrojasmonate, menthone, carvone, camphor, fenchone, alpha-ionone, beta-ionone, dihydro-beta-ionone, gamma-methyl so-called ionone, fleuramone, dihydrojasmone, cis-jasmone, iso-e-super, methyl-cedrenyl-ketone or methyl-cedrylone, acetophenone, methyl-acetophenone, para-methoxy-acetophenone, methyl-beta-naphtyl-ketone, benzyl-acetone, benzophenone, para-hydroxy-phenyl-butanone, celery ketone or livescone, 6-isopropyldecahydro-2-naphtone, dimethyl-octenone, freskomenthe, 4-(1-ethoxyvinyl)-3,3,5,5,-tetramethyl-cyclohexanone, methyl-heptenone, 2-(2-(4-methyl-3-cyclohexen-1-yl)propyl)-cyclopentanone, 1-(p-menthen-6(2)-yl)-1-propanone, 4-(4-hydroxy-3-methoxyphenyl)-2-butanone, 2-acetyl-3,3-dimethyl-norbornane, 6,7-dihydro-1,1,2,3,3-pentamethyl-4(5h)-indanone, 4-damascol, dulcinyl or cassione, gelsone, hexalon, isocyclemone e, methyl cyclocitrone, methyl-lavender-ketone, orivon, para-tertiary-butyl-cyclohexanone, verdone, delphone, muscone, neobutenone, plicatone, veloutone, 2,4,4,7-tetramethyl-oct-6-en-3-one, tetrameran, hedione, floralozone, gamma undecalactone, ethylene brassylate, pentadecanolide, methyl nonyl ketone, cyclopentadecanone, cyclic ethylene dodecanedioate, 3,4,5,6-tetrahydropseudoionone, 8-hexadecenolide, dihydrojasmone, 5-cyclohexadecenone, and a combination thereof.

The PRM comprising ketone comprises a PRM selected from the group consisting of alpha-damascone, delta-damascone, iso-damascone, carvone, gamma-methyl-ionone, beta-ionone, iso-e-super, 2,4,4,7-tetramethyl-oct-6-en-3-one, benzyl acetone, beta-damascone, damascenone, methyl dihydrojasmonate, methyl cedrylone, hedione, floralozone, and a combination thereof. Preferably, the PRM comprising ketone comprises delta-damascone.

The composition may include a mixture of aldehydes that contribute to scent character and neutralize malodors in vapor and/or liquid phase via chemical reactions. Aldehydes that are partially reactive or volatile may be considered a reactive aldehyde as used herein. Reactive aldehydes may react with amine-based odors, following the path of Schiff-base formation. Reactive aldehydes may also react with sulfur-based odors, forming thiol acetals, hemi thiolacetals, and thiol esters in vapor and/or liquid phase. It may be desirable for these vapor and/or liquid phase reactive aldehydes to have virtually no negative impact on the desired perfume character, color or stability of a product.

The composition may include a mixture of aldehydes that are partially volatile which may be considered a volatile aldehyde as used herein. The volatile aldehydes may also have a certain boiling point (B.P.) and octanol/water partition coefficient (P). The boiling point referred to herein is measured under normal standard pressure of 760 mmHg. The boiling points of many volatile aldehydes, at standard 760 mm Hg are given in, for example, “Perfume and Flavor Chemicals (Aroma Chemicals),” written and published by Steffen Arctander, 1969.

The octanol/water partition coefficient of a volatile aldehyde is the ratio between its equilibrium concentrations in octanol and in water. The partition coefficients of the volatile aldehydes used in the malodor control composition may be more conveniently given in the form of their logarithm to the base 10, log P. The log P values of many volatile aldehydes have been reported. See, e.g., the Pomona92 database, available from Daylight Chemical Information Systems, Inc. (Daylight CIS), Irvine, California. However, the log P values are most conveniently calculated by the “C LOG P” program, also available from Daylight CIS. This program also lists experimental log P values when they are available in the Pomona92 database. The “calculated log P” (C log P) is determined by the fragment approach of Hansch and Leo (cf., A. Leo, in Comprehensive Medicinal Chemistry, Vol. 4, C. Hansch, P. G. Sammens, J. B. Taylor and C. A. Ramsden, Eds., p. 295, Pergamon Press, 1990). The fragment approach is based on the chemical structure of each volatile aldehyde and takes into account the numbers and types of atoms, the atom connectivity, and chemical bonding. The C log P values, which are the most reliable and widely used estimates for this physicochemical property, are preferably used instead of the experimental log P values in the selection of volatile aldehydes for the malodor control composition.

The C log P values may be defined by four groups and the volatile aldehydes may be selected from one or more of these groups. The first group comprises volatile aldehydes that have a B.P. of about 250° C. or less and C log P of about 3 or less. The second group comprises volatile aldehydes that have a B.P. of 250° C. or less and C log P of 3.0 or more. The third group comprises volatile aldehydes that have a B.P. of 250° C. or more and C log P of 3.0 or less. The fourth group comprises volatile aldehydes that have a B.P. of 250° C. or more and C log P of 3.0 or more. The malodor control composition may comprise any combination of volatile aldehydes from one or more of the C log P groups.

The malodor control composition may comprises, by total weight of the composition, from about 0% to about 30% of volatile aldehydes from group 1, alternatively about 25%; and/or about 0% to about 10% of volatile aldehydes from group 2, alternatively about 10%; and/or from about 10% to about 30% of volatile aldehydes from group 3, alternatively about 30%; and/or from about 35% to about 60% of volatile aldehydes from group 4, alternatively about 35%.

Exemplary reactive and/or volatile aldehydes which may be used in a composition include, but are not limited to, Adoxal (2,6,10-Trimethyl-9-undecenal), Bourgeonal (4-t-butylbenzenepropionaldehyde), Lilestralis 33 (2-methyl-4-t-butylphenyl)propanal), Cinnamic aldehyde, cinnamaldehyde (phenyl propenal, 3-phenyl-2-propenal), Citral, Geranial, Neral (dimethyloctadienal, 3,7-dimethyl-2,6-octadien-1-al), Cyclal C (2,4-dimethyl-3-cyclohexen-1-carbaldehyde), Florhydral (3-(3-Isopropyl-phenyl)-butyraldehyde), Citronellal (3,7-dimethyl 6-octenal), Cymal, cyclamen aldehyde, Cyclosal, Lime aldehyde (Alpha-methyl-p-isopropyl phenyl propyl aldehyde), Methyl Nonyl Acetaldehyde, aldehyde C12 MNA (2-methyl-1-undecanal), Hydroxycitronellal, citronellal hydrate (7-hydroxy-3,7-dimethyl octan-1-al), Helional (3-(1,3-Benzodioxol-5-yl)-2-methylpropanal; 2-Methyl-3-(3,4-methylenedioxyphenyl)propanal), Intreleven aldehyde (undec-10-en-1-al), Ligustral, Trivertal (2,4-dimethyl-3-cyclohexene-1-carboxaldehyde), Jasmorange, satinaldehyde (2-methyl-3-tolylproionaldehyde, 4-dimethylbenzenepropanal), Lyral (4-(4-hydroxy-4-methyl pentyl)-3-cyclohexene-1-carboxaldehyde), Melonal (2,6-Dimethyl-5-Heptenal), Methoxy Melonal (6-methoxy-2,6-dimethylheptanal), methoxycinnamaldehyde (trans-4-methoxycinnamaldehyde), Myrac aldehyde isohexenyl cyclohexenyl-carboxaldehyde, trifernal ((3-methyl-4-phenyl propanal, 3-phenyl butanal), lilial, P.T. Bucinal, lysmeral, benzenepropanal (4-tert-butyl-alpha-methyl-hydrocinnamaldehyde), Dupical, tricyclodecylidenebutanal (4-Tricyclo5210-2,6decylidene-8butanal), Melafleur (1,2,3,4,5,6,7,8-octahydro-8,8-dimethyl-2-naphthaldehyde), Methyl Octyl Acetaldehyde, aldehyde C-11 MOA (2-mehtyl deca-1-al), Onicidal (2,6,10-trimethyl-5,9-undecadien-1-al), Citronellyl oxyacetaldehyde, Muguet aldehyde 50 (3,7-dimethyl-6-octenyl) oxyacetaldehyde), phenylacetaldehyde, Mefranal (3-methyl-5-phenyl pentanal), Triplal, Vertocitral dimethyl tetrahydrobenzene aldehyde (2,4-dimethyl-3-cyclohexene-1-carboxaldehyde), 2-phenylproprionaldehyde, Hydrotropaldehyde, Canthoxal, anisylpropanal 4-methoxy-alpha-methyl benzenepropanal (2-anisylidene propanal), Cylcemone A (1,2,3,4,5,6,7,8-octahydro-8,8-dimethyl-2-naphthaldehyde), and Precylcemone B (1-cyclohexene-1-carboxaldehyde).

Still other exemplary aldehydes include, but are not limited to, acetaldehyde (ethanal), pentanal, valeraldehyde, amylaldehyde, Scentenal (octahydro-5-methoxy-4,7-Methano-1H-indene-2-carboxaldehyde), propionaldehyde (propanal), Cyclocitral, beta-cyclocitral, (2,6,6-trimethyl-1-cyclohexene-1-acetaldehyde), Iso Cyclocitral (2,4,6-trimethyl-3-cyclohexene-1-carboxaldehyde), isobutyraldehyde, butyraldehyde, isovaleraldehyde (3-methyl butyraldehyde), methylbutyraldehyde (2-methyl butyraldehyde, 2-methyl butanal), Dihydrocitronellal (3,7-dimethyl octan-1-al), 2-Ethylbutyraldehyde, 3-Methyl-2-butenal, 2-Methylpentanal, 2-Methyl Valeraldehyde, Hexenal (2-hexenal, trans-2-hexenal), Heptanal, Octanal, Nonanal, Decanal, Laurie aldehyde, Tridecanal, 2-Dodecanal, Methylthiobutanal, Glutaraldehyde, Pentanedial, Glutaric aldehyde, Heptenal, cis or trans-Heptenal, Undecenal (2-, 10-), 2,4-octadienal, Nonenal (2-, 6-), Decenal (2-, 4-), 2,4-hexadienal, 2,4-Decadienal, 2,6-Nonadienal, Octenal, 2,6-dimethyl 5-heptenal, 2-isopropyl-5-methyl-2-hexenal, Trifernal, beta methyl Benzenepropanal, 2,6,6-Trimethyl-1-cyclohexene-1-acetaldehyde, phenyl Butenal (2-phenyl 2-butenal), 2.Methyl-3(p-isopropylphenyl)-propionaldehyde, 3-(p-isopropylphenyl)-propionaldehyde, p-Tolylacetaldehyde (4-methylphenylacetaldehyde), Anisaldehyde (p-methoxybenzene aldehyde), Benzaldehyde, Vernaldehyde (1-Methyl-4-(4-methylpentyl)-3-cyclohexenecarbaldehyde), Heliotropin (piperonal) 3,4-Methylene dioxy benzaldehyde, alpha-Amylcinnamic aldehyde, 2-pentyl-3-phenylpropenoic aldehyde, Vanillin (4-methoxy 3-hydroxy benzaldehyde), Ethyl vanillin (3-ethoxy 4-hydroxybenzaldehyde), Hexyl Cinnamic aldehyde, Jasmonal H (alpha-n-hexyl-cinnamaldehyde), Floralozone, (para-ethyl-alpha,alpha-dimethyl Hydrocinnamaldehyde), Acalea (p-methyl-alpha-pentylcinnamaldehyde), methylcinnamaldehyde, alpha-Methylcinnamaldehyde (2-methyl 3-pheny propenal), alpha-hexylcinnamaldehyde (2-hexyl 3-phenyl propenal), Salicylaldehyde (2-hydroxy benzaldehyde), 4-ethyl benzaldehyde, Cuminaldehyde (4-isopropyl benzaldehyde), Ethoxybenzaldehyde, 2,4-dimethylbenzaldehyde, Veratraldehyde (3,4-dimethoxybenzaldehyde), Syringaldehyde (3,5-dimethoxy 4-hydroxybenzaldehyde), Catechaldehyde (3,4-dihydroxybenzaldehyde), Safranal (2,6,6-trimethyl-1,3-diene methanal), Myrtenal (pin-2-ene-1-carbaldehyde), Perillaldehyde L-4(1-methylethenyl)-1-cyclohexene-1-carboxaldehyde), 2,4-Dimethyl-3-cyclohexene carboxaldehyde, 2-Methyl-2-pentenal, 2-methylpentenal, pyruvaldehyde, formyl Tricyclodecan, Mandarin aldehyde, Cyclemax, Pino acetaldehyde, Corps Iris, Maceal, and Corps 4322.

The composition may comprise polyols. Low molecular weight polyols with relatively high boiling points, as compared to water, such as ethylene glycol, diethylene glycol, triethylene glycol, propylene glycol, dipropylene glycol, and/or glycerine may be utilized as a malodor counteractant for improving odor neutralization of the composition. Some polyols, e.g., dipropylene glycol, are also useful to facilitate the solubilization of some perfume ingredients in the composition.

The glycol may be glycerine, ethylene glycol, propylene glycol, dipropylene glycol, polyethylene glycol, propylene glycol methyl ether, propylene glycol phenyl ether, propylene glycol methyl ether acetate, dipropylene glycol methyl ether acetate, propylene glycol n-butyl ether, dipropylene glycol n-butyl ether, dipropylene glycol n-propyl ether, ethylene glycole phenyl ether, diethylene glycol n-butyl ether, dipropylene glycol n-butyl ether, diethylene glycol mono butyl ether, dipropylene glycol methyl ether, tripropylene glycol methyl ether, tripropylene glycol n-butyl ether, other glycol ethers, or mixtures thereof. The glycol used may be ethylene glycol, propylene glycol, or mixtures thereof. The glycol used may be diethylene glycol.

A low molecular weight polyol may be added to the composition at a level of from about 0.01% to about 5%, by weight of the composition, alternatively from about 0.05% to about 1%, alternatively from about 0.1% to about 0.5%, by weight of the composition. Compositions with higher concentrations may make fabrics susceptible to soiling and/or leave unacceptable visible stains on fabrics as the solution evaporates off of the fabric. The weight ratio of low molecular weight polyol to the malodor binding polymer is from about 500:1 to about 4:1, alternatively from about 1:100 to about 25:1, alternatively from about 1:50 to about 4:1, alternatively about 4:1.

The composition may include solubilized, water-soluble, uncomplexed cyclodextrin. As used herein, the term “cyclodextrin” includes any of the known cyclodextrins such as unsubstituted cyclodextrins containing from six to twelve glucose units, especially alpha-cyclodextrin, beta-cyclodextrin, gamma-cyclodextrin and/or their derivatives and/or mixtures thereof. The alpha-cyclodextrin consists of six glucose units, the beta-cyclodextrin consists of seven glucose units, and the gamma-cyclodextrin consists of eight glucose units arranged in a donut-shaped ring. The specific coupling and conformation of the glucose units give the cyclodextrins a rigid, conical molecular structure with a hollow interior of a specific volume. The “lining” of the internal cavity is formed by hydrogen atoms and glycosidic bridging oxygen atoms, therefore this surface is fairly hydrophobic. The unique shape and physical-chemical property of the cavity enable the cyclodextrin molecules to absorb (form inclusion complexes with) organic molecules or parts of organic molecules which can fit into the cavity. Many perfume molecules can fit into the cavity.

Cyclodextrin molecules are described in U.S. Pat. Nos. 5,714,137 and 5,942,217. Cyclodextrin, if present, may be present at from about 0.1% to about 5%, alternatively from about 0.2% to about 4%, alternatively from about 0.3% to about 3%, alternatively from about 0.4% to about 2%, by weight of the composition. Compositions with higher concentrations can make fabrics susceptible to soiling and/or leave unacceptable visible stains on fabrics as the solution evaporates off of the fabric. The latter is especially a problem on thin, colored, synthetic fabrics. In order to avoid or minimize the occurrence of fabric staining, the fabric may be treated at a level of less than about 5 mg of cyclodextrin per mg of fabric, alternatively less than about 2 mg of cyclodextrin per mg of fabric.

The composition may include a buffering agent. The buffering agent may be an acidic buffering agent. The buffering agent may be a dibasic acid, carboxylic acid, or a dicarboxylic acid. The carboxylic acid may be, for example, citric acid, polyacrylic acid, or maleic acid. The acid may be sterically stable. The acid may be used in the composition for maintaining the desired pH. The composition may have a pH from about 4 to about 11, alternatively from about 4 to about 9, alternatively from about 4 to about 6.9, alternatively about 4 to about 7.

The buffer system may comprise one or more buffering agents selected from the group consisting of: citric acid, maleic acid, polyacrylic acid, and combinations thereof. It has been found that buffer systems that include a buffering agent selected from the group consisting of: citric acid, maleic acid, polyacrylic acid, and combinations thereof provide stable compositions with prolonged shelf life.

The buffer system may comprise citric acid and sodium citrate. It has been found that buffer systems comprising citric acid and sodium citrate provide stable compositions with a prolonged shelf life.

Other suitable buffering agents for the compositions include biological buffering agents. Some examples are nitrogen-containing materials, sulfonic acid buffers like 3-(N-morpholino)propanesulfonic acid (MOPS) or N-(2-Acetamido)-2-aminoethanesulfonic acid (ACES), which have a near neutral 6.2 to 7.5 pKa and provide adequate buffering capacity at a neutral pH. Other examples are amino acids such as lysine or lower alcohol amines like mono-, di-, and tri-ethanolamine or methyldiethanolamine or derivatives thereof. Other nitrogen-containing buffering agents are tri(hydroxymethyl)amino methane (HOCH2)3CNH3 (TRIS), 2-amino-2-ethyl-1,3-propanediol, 2-amino-2-methyl-propanol, 2-amino-2-methyl-1,3-propanol, disodium glutamate, N-methyl diethanolamide, 2-dimethylamino-2-methylpropanol (DMAMP), 1,3-bis(methylamine)-cyclohexane, 1,3-diamino-propanol N,N′-tetra-methyl-1,3-diamino-2-propanol, N,N-bis(2-hydroxyethyl)glycine (bicine) and N-tris (hydroxymethyl)methyl glycine (tricine). Mixtures of any of the above are also acceptable.

The composition may include a secondary or tertiary amine. If a secondary or tertiary amine is present, the composition may have a weight ratio of sulfur-containing pro-perfume to secondary or tertiary amine of about 1:1, alternatively the weight of pro-perfume should be equal or higher than the weight of the amine, based on the total weight of the composition. If a secondary or tertiary amine is present, the weight ratio of acidic buffering agent to secondary or tertiary amine may be equal to or greater than 3:1, or greater than 5:1, or greater than 6:1.

The composition may be free of primary amines. Without being bound to theory, it is believed that primary amines inhibit the sulfur-containing pro-perfume reaction with the unstable perfume raw materials.

The compositions may contain at least about 0%, alternatively at least about 0.001%, alternatively at least about 0.01%, by weight of the composition, of a buffering agent. The composition may also contain no more than about 1%, alternatively no more than about 0.75%, alternatively no more than about 0.5%, by weight of the composition, of a buffering agent.

The composition may contain a solubilizing aid to solubilize any excess hydrophobic organic materials, particularly any PRMs, and also optional ingredients (e.g., insect repelling agent, antioxidant, etc.) which can be added to the composition, that are not readily soluble in the composition, to form a clear solution. A suitable solubilizing aid is a surfactant, such as a no-foaming or low-foaming surfactant. Suitable surfactants are anionic surfactants, nonionic surfactants, cationic surfactants, amphoteric surfactants, zwitterionic surfactants, and mixtures thereof.

The composition may contain nonionic surfactants, cationic surfactants, and mixtures thereof. The composition may contain surfactant derivatives of hydrogenated castor oil. Suitable ethoxylated hydrogenated castor oils that may be used in the present composition include BASOPHOR™, available from BASF, and CREMOPHOR™, available from Sigma Aldrich.

When the solubilizing agent is present, it may be present at a level of from about 0.01% to about 3%, alternatively from about 0.05% to about 1%, alternatively from about 0.01% to about 0.05%, by weight of the composition.

The composition may include an effective amount of a compound for reducing microbes in the air or on inanimate surfaces. Antimicrobial compounds are effective on gram negative and gram positive bacteria and fungi typically found on indoor surfaces that have contacted human skin or pets such as couches, pillows, pet bedding, and carpets. Such microbial species include Klebsiella pneumoniae, Staphylococcus aureus, Aspergillus niger, Klebsiella pneumoniae, Steptococcus pyogenes, Salmonella choleraesuis, Escherichia coli, Trichophyton mentagrophytes, and Pseudomonoas aeruginosa. The antimicrobial compounds may also effective on viruses such H1-N1, Rhinovirus, Respiratory Syncytial, Poliovirus Type 1, Rotavirus, Influenza A, Herpes simplex types 1 & 2, Hepatitis A. and Human Coronavirus.

Antimicrobial compounds suitable in the composition can be any organic material which will not cause damage to fabric appearance (e.g., discoloration, coloration such as yellowing, bleaching). Water-soluble antimicrobial compounds include organic sulfur compounds, halogenated compounds, cyclic organic nitrogen compounds, low molecular weight aldehydes, quaternary compounds, dehydroacetic acid, phenyl and phenoxy compounds, or mixtures thereof.

The composition may include a quaternary compound. Examples of commercially available quaternary compounds suitable for use in the composition is BARQUAT® available from Lonza Corporation; and didecyl dimethyl ammonium chloride quat under the trade name BARDAC® 2250 from Lonza Corporation.

The antimicrobial compound, if present, may be present in an amount from about 500 ppm to about 7000 ppm, alternatively from about 1000 ppm to about 5000 ppm, alternatively from about 1000 ppm to about 3000 ppm, alternatively from about 1400 ppm to about 2500 ppm, by weight of the composition.

The composition may include a preservative. The preservative may be included in an amount sufficient to prevent spoilage or prevent growth of inadvertently added microorganisms for a specific period of time, but not sufficient enough to contribute to the odor neutralizing performance of the composition. In other words, the preservative is not being used as the antimicrobial compound to kill microorganisms on the surface onto which the composition is deposited in order to eliminate odors produced by microorganisms. Instead, it is being used to prevent spoilage of the composition in order to increase the shelf-life of the composition.

The preservative can be any organic preservative material which will not cause damage to fabric appearance, e.g., discoloration, coloration, bleaching. Suitable water-soluble preservatives include organic sulfur compounds, halogenated compounds, cyclic organic nitrogen compounds, low molecular weight aldehydes, parabens, propane diaol materials, isothiazolinones, quaternary compounds, benzoates, low molecular weight alcohols, dehydroacetic acid, phenyl and phenoxy compounds, or mixtures thereof.

Non-limiting examples of water-soluble preservatives include a mixture of about 77% 5-chloro-2-methyl-4-isothiazolin-3-one and about 23% 2-methyl-4-isothiazolin-3-one, a broad spectrum preservative available as a 1.5% freshening solution under the trade name Kathon® CG by Rohm and Haas Co.; 5-bromo-5-nitro-1,3-dioxane, available under the tradename Bronidox L® from Henkel; 2-bromo-2-nitropropane-1,3-diol, available under the trade name Bronopol® from Inolex; 1,1′-hexamethylene bis(5-(p-chlorophenyl)biguanide), commonly known as chlorhexidine, and its salts, e.g., with acetic and digluconic acids; a 95:5 mixture of 1,3-bis(hydroxymethyl)-5,5-dimethyl-2,4-imidazolidinedione and 3-butyl-2-iodopropynyl carbamate, available under the trade name Glydant Plus® from Lonza; N-[1,3-bis(hydroxymethyl)2,5-dioxo-4-imidazolidinyl]-N,N′-bis(hydroxy-methyl) urea, commonly known as diazolidinyl urea, available under the trade name Germall® II from Sutton Laboratories, Inc.; N,N″-methylenebis{N′-[1-(hydroxymethyl)-2,5-dioxo-4-imidazolidinyl]urea}, commonly known as imidazolidinyl urea, available, e.g., under the trade name Abiol® from 3V-Sigma; Unicide U-13® from Induchem; Germall 115® from Sutton Laboratories, Inc.; polymethoxy bicyclic oxazolidine, available under the trade name Nuosept® C from Hiils America; formal-dehyde; glutaraldehyde; polyaminopropyl biguanide, available under the trade name Cosmocil CQ® from ICI Americas, Inc., or under the trade name Mikrokill® from Brooks, Inc; dehydroacetic acid; and benzsiothiazolinone available under the trade name Koralone™ B-119 from Rohm and Hass Corporation.

The preservative, if present, may be present at a level of from about 0.0001% to about 0.5%, alternatively from about 0.0002% to about 0.2%, alternatively from about 0.0003% to about 0.1%, by weight of the composition.

The composition may include a wetting agent that provides a low surface tension that permits the composition to spread readily and more uniformly on hydrophobic surfaces like polyester and nylon. The spreading of the composition also allows it to dry faster, so that the treated material is ready to use sooner. Furthermore, a composition containing a wetting agent may penetrate hydrophobic, oily soil better for improved malodor neutralization. A composition containing a wetting agent may also provide improved “in-wear” electrostatic control. For concentrated compositions, the wetting agent facilitates the dispersion of many actives such as antimicrobial actives and perfumes in the concentrated compositions.

Non-limiting examples of wetting agents include block copolymers of ethylene oxide and propylene oxide. Suitable block polyoxyethylene-polyoxypropylene polymeric surfactants include those based on ethylene glycol, propylene glycol, glycerol, trimethylolpropane and ethylenediamine as the initial reactive hydrogen compound. Polymeric compounds made from a sequential ethoxylation and propoxylation of initial compounds with a single reactive hydrogen atom, such as C₁₂₋₁₈ aliphatic alcohols, are not generally compatible with the cyclodextrin. Certain of the block polymer surfactant compounds designated Pluronic® and Tetronic® by the BASF-Wyandotte Corp., Wyandotte, Michigan, are readily available.

Non-limiting examples of cyclodextrin-compatible wetting agents of this type are described in U.S. Pat. No. 5,714,137 and include the Silwet® surfactants available from Momentive Performance Chemical, Albany, New York. Exemplary Silwet surfactants are as follows:
Name Average MW
L-7608 600;
L-7607 1,000;
L-77 600;
L-7605 6,000;
L-7604 4,000;
L-7600 4,000;
L-7657 5,000;
L-7602 3,000;
and mixtures thereof.

The total amount of surfactants (e.g. solubilizer, wetting agent) present in the composition may be from 0% to about 3% or no more than 3%, alternatively from 0% to about 1% or no more than 1%, alternatively from 0% to about 0.9% or no more than 0.9%, alternatively from 0% to about 0.7 or no more than 0.7%, alternatively from 0% to about 0.5% or no more than 0.5%, alternatively from 0% to 0.3% or no more than about 0.3%, by weight of the composition. Compositions with higher concentrations may make fabrics susceptible to soiling and/or leave unacceptable visible stains on fabrics as the solution evaporates.

The aqueous composition may include a carrier. The carrier may be water. The water may be distilled, deionized, tap, or further purified forms of water. Water may be present in any amount for the composition to be an aqueous solution. Water may be present in an amount from about 85% to 99.5%, alternatively from about 90% to about 99.5%, alternatively from about 92% to about 99.5%, alternatively from about 95%, by weight of said composition. Water containing a small amount of low molecular weight monohydric alcohols (e.g., ethanol, methanol, and isopropanol, or polyols, such as ethylene glycol and propylene glycol) can also be useful. However, the volatile low molecular weight monohydric alcohols such as ethanol and/or isopropanol should be limited since these volatile organic compounds will contribute both to flammability problems and environmental pollution problems. If small amounts of low molecular weight monohydric alcohols are present in the composition due to the addition of these alcohols to such things as perfumes and as stabilizers for some preservatives, the level of monohydric alcohol may be less than about 6%, alternatively less than about 3%, alternatively less than about 1%, by weight of the composition.

Adjuvants can be optionally added to the composition herein for their known purposes. Such adjuvants include, but are not limited to, water soluble metallic salts, antistatic agents, insect and moth repelling agents, colorants, antioxidants, and mixtures thereof.

In examples, the composition 208 may be a hard surface cleaning composition, such as a detergent composition.

### The Detergent Composition

The detergent composition is a liquid composition. The composition is typically an aqueous composition and therefore can comprise water. The composition may comprise from 50% to 98%, even more preferably of from 75% to 97% and most preferably 80% to 97% by weight of water.

The pH of the composition according to the present invention may be greater than 7.0, preferably from 7.0 to 13, more preferably from 8.5 to 12.5, even more preferably from 9.5 to 12, most preferably 10.5 to 11.5, when measured on the neat composition, at 25° C.

The composition may comprise an acid or a base to adjust pH as appropriate.

A suitable acid for use herein is an organic and/or an inorganic acid. A preferred organic acid for use herein has a pKa of less than 6. A suitable organic acid is selected from the group consisting of citric acid, lactic acid, glycolic acid, succinic acid, glutaric acid and adipic acid and a mixture thereof. A suitable inorganic acid is selected from the group consisting hydrochloric acid, sulphuric acid, phosphoric acid and a mixture thereof. A typical level of such acid, when present, is of from 0.01% to 2.0%, from 0.1% to 1.5%, or from 0.5% to 1% by weight of the total composition.

A suitable base to be used herein is an organic and/or inorganic base. Suitable bases for use herein include alkali metal salts, caustic alkalis, such as sodium hydroxide and/or potassium hydroxide, and/or the alkali metal oxides such, as sodium and/or potassium oxide or mixtures thereof. A preferred base is a caustic alkali, more preferably sodium hydroxide and/or potassium hydroxide. Other suitable bases include ammonia.

The composition can comprise an alkali metal salt selected from carbonate salt, silicate salt, phosphate salt and sulphate salt.

Carbonate salts are particularly preferred, especially carbonate salts selected from the group consisting of: sodium carbonate, sodium bicarbonate, and mixtures thereof. Preferably the carbonate salt is sodium carbonate.

The composition may comprise from 0.01% to 2.0% by weight of the base, or from 0.02% to 1.0% or from 0.05% to 0.5% by weight.

### Thickener:

The detergent composition is a thickened composition. The detergent composition can comprise the thickener at a level of less than 0.5%, preferably 0.01% to 0.5%, more preferably from 0.05% to 0.2% by weight of the composition. Thickened detergent compositions also result in more effective cleaning of inclined surfaces since less of the composition runs off the inclined surface, particularly when the detergent composition is applied as a fine spray.

Suitable thickeners include thickeners selected from the group consisting of: hydrocolloid thickener, ASE (Alkali Swellable Emulsion) thickener, HASE (Hydrophobically modified alkali-swellable emulsion) thickener, HEUR (Hydrophobically-modified Ethylene oxide-based URethane) thickener, and mixtures thereof, though hydrocolloid thickeners and HASE thickeners are most preferred. Hydrocolloid thickeners are most preferred.

Hydrocolloid thickeners and their use in foods is described in: “Hydrocolloids as thickening and gelling agents in food: a critical review” (J Food Sci Technol (November-December 2010) 47(6):587-597). Hydrocolloids typically thicken through the nonspecific entanglement of conformationally disordered polymer chains. The thickening effect produced by the hydrocolloids depends on the type of hydrocolloid used, its concentration, the composition in which it is used and often also the pH of the composition.

Suitable hydrocolloid thickeners can be selected from the group consisting of: carbomers, polysaccharide thickeners, more preferably polysaccharide thickeners selected from the group consisting of: carboxymethylcellulose, ethyl cellulose, hydroxyethyl cellulose, hydroxypropyl cellulose, hydroxymethyl cellulose, succinoglycan, xanthan gum, gellan gum, guar gum, locust bean gum, tragacanth gum, and mixtures thereof, most preferably xanthan gum.

Carbomers are cross-linked acrylic acids, typically with a polyfunctional compound, and are used as suspending agents, including for pharmaceuticals. Suitable carbomers include Carbomer® 940, supplied by Lubrizol.

The polysaccharide thickener can be selected from the group consisting of: carboxymethylcellulose, ethyl cellulose, hydroxyethyl cellulose, hydroxypropyl cellulose, hydroxymethyl cellulose, succinoglycan gum, xanthan gum, gellan gum, guar gum, locust bean gum, tragacanth gum, derivatives of the aforementioned, and mixtures thereof. Preferably, the polysaccharide thickener can be selected from the group consisting of: succinoglycan gum, xanthan gum, gellan gum, guar gum, locust bean gum, tragacanth gum, derivatives of the aforementioned, and mixtures thereof. More preferably, the polysaccharide thickener can be selected from the group consisting of: xanthan gum, gellan gum, guar gum, derivatives of the aforementioned, and mixtures thereof.

Particularly polysaccharide thickeners for use herein are xanthan gum and derivatives thereof. Xanthan gum and derivatives thereof may be commercially available for instance from CP Kelco under the trade name Keltrol RD®, Kelzan S® or Kelzan T®. Other suitable xanthan gums are commercially available by Rhodia under the trade name Rhodopol T® and Rhodigel X747®. Succinoglycan gum for use herein is commercially available by Rhodia under the trade name Rheozan®.

HEUR polymeric structurants are water-soluble polymers, having hydrophobic end-groups, typically comprising blocks of ethylene glycol units, propylene glycol units, and mixtures thereof, in addition to urethane units. The HEUR polymeric structurants preferably has a backbone comprising one or more polyoxyalkylene segments greater than 10 oxyalkylene units in length. The HEUR polymeric structurant is preferably a hydrophobically modified polyurethane polyether comprising the reaction product of a dialkylamino alkanol with a multi-functional isocyanate, a polyether diol, and optionally a polyether triol. Preferably, the polyether diol has a weight average molecular weight between 2,000 and 12,000, preferably between 6,000 and 10,000 g/mol.

Preferred HEUR polymeric structurants can have the following structure:

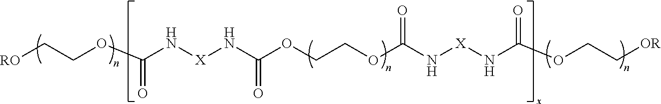

wherein:
R is an alkyl chain, preferably a C6-C24 alkyl chain, more preferably a C12-C18 alkyl chain, n is preferably from 25 to 400, preferably from 50 to 250, more preferably from 75 to 180, X can be any suitable linking group.

Suitable HEUR polymeric structurants can have a molecular weight of from 1,000 to 1,000,000, more preferably from 15,000 to 50,000 g/mol. An example of a suitable HEUR polymeric structurant is ACUSOL™ 880, sold by DOW.

It is believed that HEUR polymeric structurants thicken via an associative mechanism, wherein the hydrophobic parts of HEUR polymers build up associations with other hydrophobes present in the composition, such as the insoluble or weakly soluble ingredient.

HEUR polymers are typically synthesized from an alcohol, a diisocyanate and a polyethylene glycol.

Preferred HASE polymeric structurants can have the following structure:

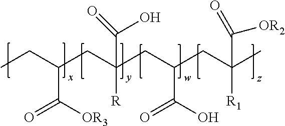

wherein:
R is preferably H or an alkyl group. When R is an alkyl group, R is preferably a C1-C6 alkyl group, more preferably a C1 to C2 alkyl group. R is preferably a C1 alkyl group.
R₁ is preferably H or an alkyl group. When R₁ is an alkyl group, R is preferably a C1-C6 alkyl group, more preferably a C1 to C2 alkyl group. R₁ is preferably a C1 alkyl group.
R₂ is any suitable hydrophobic group, such as a C4-C24 alkyl group, more preferably a C8-C20 alkyl group. R₂ can also be alkoxylated. Preferably, R₂ is ethoxylated, propoxylated, and combinations thereof. More preferably R₂ is ethoxylated. When alkoxylated, R₂ can be alkoxylated to a degree of from 1 to 60, preferably from 10 to 50.
R₃ is preferably H or an alkyl group. When R₃ is an alkyl group, R₃ is preferably a C1-C6 alkyl group, more preferably a C1 to C3 alkyl group. R₃ is preferably a C2 alkyl group.

The repeating units comprising R, R₁, R₂, and R₃ can be in any suitable order, or even randomly distributed through the polymer chain.

Suitable HASE polymeric structurants can have a molecular weight of from 50,000 to 500,000 g/mol, preferably from 80,000 to 400,000 g/mol, more preferably from 100,000 to 300,000 g/mol.

The ratio of x:y can be from 1:20 to 20:1, preferably from 1:10 to 10:1, more preferably from 1:5 to 5:1. The ratio of x:w can be from 1:20 to 20:1, preferably from 1:10 to 10:1, more preferably from 1:5 to 5:1. The ratio of x:z can be from 1:1 to 500:1, preferably from 2:1 to 250:1, more preferably from 25:1 to 75:1.

Examples of a suitable HASE polymeric structurants are ACUSOL™ 801S, ACUSOL™805S, ACUSOL™ 820, ACUSOL™ 823, sold by DOW.

HASE polymeric structurants are believed to structure by a combination of polyelectrolytic chain expansion and through association of the hydrophobe groups, present in the HASE polymeric structurant, with other hydrophobes present in the composition, such as the insoluble or weakly soluble ingredient.

HASE polymers are typically synthesized from an acid/acrylate copolymer backbone and include an ethoxylated hydrophobe. These products are also typically made through emulsion polymerization. Methods of making such HASE polymeric structurants are described in U.S. Pat. Nos. 4,514,552, 5,192,592, British Patent No. 870,994, and U.S. Pat. No. 7,217,443.

The composition may have a viscosity at shear rate 10 s⁻¹ of 1 mPa·s or greater, more preferably of from 1 to 20,000 mPa·s, or from 1.5 to 100 mPa·s, or from 1.5 to 30 mPa·s, or from 2 to 10 mPa·s, or from 2.5 to 5 mPa·s at 20° C. when measured with a DHR1 rheometer (TA instruments) using a 2° 40 mm diameter cone/plate geometry, with a shear rate ramp procedure from 1 to 1000 s⁻¹.

### Surfactant System:

By optimizing the spray droplet size distribution, the detergent composition provides effective cleaning even at low levels of surfactant. As such, the detergent composition comprises the surfactant system at a level of less than 5%, preferably from 0.1% to 3.0%, more preferably from 0.5% to 1.5% by weight of the detergent composition.

### Nonionic Surfactant:

The surfactant system preferably comprises nonionic surfactant, preferably selected from the group consisting of: alkoxylated nonionic surfactant, amine oxide surfactant, and mixtures thereof. More preferably, the nonionic surfactant comprises alkoxylated nonionic surfactant and amine oxide surfactant. Most preferably, the nonionic surfactant comprises branched alkoxylated nonionic surfactant and amine oxide surfactant.

The nonionic surfactant can be present at a level of from 0.05% to less than 5.0%, preferably from 0.1% to 3.0%, more preferably from 0.5% to 1.5% by weight of the detergent composition.

### Alkoxylated Alcohol:

Suitable alkoxylated alcohols can be linear or branched, though branched alkoxylated alcohols are preferred since they further improve spray visibility on the treated hard surface, and results in faster cleaning kinetics.

Suitable branched alkoxylated alcohol can be selected from the group consisting of: C4-C10 alkyl branched alkoxylated alcohols, and mixtures thereof.

The branched alkoxylated alcohol can be derived from the alkoxylation of C4-C10 alkyl branched alcohols selected form the group consisting of: C4-C10 primary mono-alcohols having one or more C1-C4 branching groups.

The C4-C10 primary mono-alcohol can be selected from the group consisting of: methyl butanol, ethyl butanol, methyl pentanol, ethyl pentanol, methyl hexanol, ethyl hexanol, propyl hexanol, dimethyl hexanol, trimethyl hexanol, methyl heptanol, ethyl heptanol, propyl heptanol, dimethyl heptanol, trimethyl heptanol, methyl octanol, ethyl octanol, propyl octanol, butyl octanol, dimethyl octanol, trimethyl octanol, methyl nonanol, ethyl nonanol, propyl nonanol, butyl nonanol, dimethyl nonanol, trimethyl nonanol and mixtures thereof.

The C4-C10 primary mono-alcohol can be selected from the group consisting of: ethyl hexanol, propyl hexanol, ethyl heptanol, propyl heptanol, ethyl octanol, propyl octanol, butyl octanol, ethyl nonanol, propyl nonanol, butyl nonanol, and mixtures thereof.

Preferably the C4-C10 primary mono-alcohol is selected from the group consisting of: ethyl hexanol, propyl hexanol, ethyl heptanol, propyl heptanol, and mixtures thereof.

The C4-C10 primary mono-alcohol is most preferably ethyl hexanol.

In the branched alkoxylated alcohol, the one or more C1-C4 branching group can be substituted into the C4-C10 primary mono-alcohol at a C1 to C3 position, preferably at the C1 to C2 position, more preferably at the C2 position, as measured from the hydroxyl group of the starting alcohol.

The branched alkoxylated alcohol can comprise from 1 to 9, preferably from 2 to 7, more preferably from 4 to 6 ethoxylate units, and optionally from 1 to 9, preferably from 2 to 7, more preferably from 4 to 6 of propoxylate units.

The branched alkoxylated alcohol is preferably 2-ethyl hexan-1-ol ethoxylated to a degree of from 4 to 6, and propoxylated to a degree of from 4 to 6, more preferably, the alcohol is first propoxylated and then ethoxylated.

The detergent composition can comprise the branched alkoxylated alcohol at a level of from 0.01% to 5.0%, preferably from 0.1% to 1.0%, more preferably from 0.20% to 0.60% by weight of the composition. Higher levels of branched alkoxylated alcohol have been found to reduce of surface shine.

Suitable branched alkoxylated alcohols are, for instance Ecosurf® EH3, EH6, and EH9, commercially available from DOW, Lutensol XP and XL alkoxylated Guerbet alcohols, available from BASF.

Suitable linear alkoxylated nonionic surfactants include primary C₆-C₁₈ alcohol polyglycol ether i.e. ethoxylated alcohols having 6 to 16 carbon atoms in the alkyl moiety and 4 to 30 ethylene oxide (EO) units. When referred to for example C₉₋₁₄ it is meant average carbons in the alkyl chain and when referred to for example EO8 it is meant average ethylene oxide units in the head-group.

Suitable linear alkoxylated nonionic surfactants are according to the formula RO-(A)nH, wherein: R is a C₆ to C₁₈, preferably a C₈ to C₁₆, more preferably a C₈ to C₁₂ alkyl chain, or a C₆ to C₁₈ alkyl benzene chain; A is an ethoxy or propoxy or butoxy unit, and n is from 1 to 30, preferably from 1 to 15 and, more preferably from 4 to 12 even more preferably from 5 to 10.

Suitable linear ethoxylated nonionic surfactants for use herein are Dobanol® 91-2.5 (HLB=8.1; R is a mixture of C₉ and C₁₁ alkyl chains, n is 2.5), Dobanol® 91-10 (HLB=14.2; R is a mixture of C₉ to C₁₁ alkyl chains, n is 10), Dobanol® 91-12 (HLB=14.5; R is a mixture of C₉ to C₁₁ alkyl chains, n is 12), Greenbentine DE80 (HLB=13.8, 98 wt % C10 linear alkyl chain, n is 8), Marlipal 10-8 (HLB=13.8, R is a C10 linear alkyl chain, n is 8), Isalchem® 11-5 (R is a mixture of linear and branched C11 alkyl chain, n is 5), Isalchem® 11-21 (R is a C₁₁ branched alkyl chain, n is 21), Empilan® KBE21 (R is a mixture of C₁₂ and C₁₄ alkyl chains, n is 21) or mixtures thereof. Preferred herein are Dobanol® 91-5, Neodol® 11-5, Isalchem® 11-5, Isalchem® 11-21, Dobanol® 91-8, or Dobanol® 91-10, or Dobanol® 91-12, or mixtures thereof. These Dobanol®/Neodol® surfactants are commercially available from SHELL. These Lutensol® surfactants are commercially available from BASF and these Tergitol® surfactants are commercially available from Dow Chemicals.

Suitable chemical processes for preparing the linear alkoxylated nonionic surfactants for use herein include condensation of corresponding alcohols with alkylene oxide, in the desired proportions. Such processes are well known to the person skilled in the art and have been extensively described in the art, including the OXO process and various derivatives thereof. Suitable alkoxylated fatty alcohol nonionic surfactants, produced using the OXO process, have been marketed under the tradename NEODOL® by the Shell Chemical Company. Alternatively, suitable alkoxylated nonionic surfactants can be prepared by other processes such as the Ziegler process, in addition to derivatives of the OXO or Ziegler processes.

Preferably, said linear alkoxylated nonionic surfactant is a C₉₋₁₁ EO5 alkylethoxylate, C₁₂₋₁₄ EO5 alkylethoxylate, a C₁₁ EO5 alkylethoxylate, C₁₂₋₁₄ EO21 alkylethoxylate, or a C₉₋₁₁ EO8 alkylethoxylate or a mixture thereof. Most preferably, said alkoxylated nonionic surfactant is a C₁₁ EO5 alkylethoxylate or a C₉₋₁₁ EO8 alkylethoxylate or a mixture thereof.

When present, the detergent composition can comprise linear alkoxylated nonionic surfactant at a level of from 0.01% to 5.0%, preferably from 0.1% to 1.0%, more preferably from 0.20% to 0.60% by weight of the composition.

### Amine Oxide Surfactant:

Amine oxide surfactants are highly desired since they are particularly effective at removing grease.

Suitable amine oxide are according to the formula: R₁R₂R₃NO wherein each of R₁, R₂ and R₃ is independently a saturated or unsaturated, substituted or unsubstituted, linear or branched, hydrocarbon chain of from 1 to 30 carbon atoms. Preferred amine oxide surfactants to be used according to the present invention are amine oxides having the following formula: R₁R₂R₃NO wherein R₁ is an hydrocarbon chain comprising from 1 to 30 carbon atoms, preferably from 6 to 20, more preferably from 8 to 16 and wherein R₂ and R₃ are independently saturated or unsaturated, substituted or unsubstituted, linear or branched hydrocarbon chains comprising from 1 to 4 carbon atoms, preferably from 1 to 3 carbon atoms, and more preferably are methyl groups. R₁ may be a saturated or unsaturated, substituted or unsubstituted, linear or branched, hydrocarbon chain.

Suitable amine oxides for use herein are for instance C₁₂-C₁₄ dimethyl amine oxide, commercially available from Albright & Wilson; C₁₂-C₁₄ amine oxides commercially available under the trade name Genaminox® LA, from Clariant; AROMOX® DMC from AKZO Nobel; and C₁₂₋₁₄ alkyldimethyl, N-Oxide or EMPIGEN® OB/EG from Huntsman.

The detergent composition can comprise amine oxide surfactant at a level of from 0.1 wt % to 1.5 wt %, preferably 0.15 wt % to 1.0 wt %, more preferably from 0.25 wt % to 0.75 wt %.

In addition, amine oxide surfactants are particularly effective at solubilizing perfumes, even in low surfactant compositions as described herein.

As such, when the hard surface cleaning compositions comprises amine oxide surfactant, the hard surface cleaning composition can comprise perfume at a level of greater than 0.05%, preferably from 0.05% to 1.0%, more preferably from 0.1% to 0.5% by weight of the composition, even when the surfactant system is present at the low levels described herein.

### Further Nonionic Surfactant:

The surfactant system further can comprise further nonionic surfactant. The further nonionic surfactant can be selected from the group consisting of: alkyl polyglycosides, and mixtures thereof.

Alkyl polyglycosides are biodegradable nonionic surfactants which are well known in the art. Suitable alkyl polyglycosides can have the general formula CₙH₂ₙ₊₁O(C₆H₁₀O₅)ₓH wherein n is preferably from 9 to 16, more preferably 11 to 14, and x is preferably from 1 to 2, more preferably 1.3 to 1.6. Such alkyl polyglycosides provide a good balance between anti-foam activity and detergency. Alkyl polyglycoside surfactants are commercially available in a large variety. An example of a very suitable alkyl poly glycoside product is Plantaren® APG 600 (supplied by BASF), which is essentially an aqueous dispersion of alkyl polyglycosides wherein n is about 13 and x is about 1.4.

When present, the detergent composition can comprise alkyl polyglycoside surfactant at a level of from 0.01% to 5.0%, preferably from 0.1% to 1.0%, more preferably from 0.20% to 0.60% by weight of the composition.

The nonionic surfactant is preferably a low molecular weight nonionic surfactant, having a molecular weight of less than 950 g/mol, more preferably less than 500 g/mol.

### Anionic or Cationic Surfactant

The composition preferably comprises nonionic surfactant and low levels or no anionic surfactant. As such, the surfactant system can comprise anionic surfactant at a level of less than 0.3%, preferably less than 0.15% of the composition, more preferably the composition is free of anionic surfactant. Anionic surfactants have been found to reduce surface shine, especially when hard water ions are present, for instance, when rinsing the surface with tap water after the spray application.

The composition preferably does not comprise cationic surfactant since such surfactants typically result in less shine of the surfaces after treatment.

### High Molecular Weight Polymer:

The detersive composition can comprise a high molecular weight polymer. With the addition of the polymer having a molecular weight of greater than 100,000 Daltons, less thickener is required in order to provide the desired cling to inclined surfaces, and more consistent spray droplet size with less ultra-fine droplets.

Suitable polymers have a weight average molecular weight of greater than 10,000 Da, or from 10,000 Da to 10,000,000 Da, preferably from 100,000 Da to 2,000,000 Da, most preferably from 500,000 Da to 1,250,000 Da.

The polymer can comprise monomers of: ethylene glycol, propylene glycol; and mixtures thereof, preferably ethylene glycol. The polymer can comprise the monomer at a level of greater than 20 mol %, preferably greater than 50 mol %, more preferably greater than 80 mol %. Most preferably the polymer is a homopolymer. Homopolymers of ethylene glycol are particularly preferred.

The polymer is preferably essentially linear, more preferably linear. The linearity can be measured by counting the average number of end-groups per molecule and the number of repeating units, such as via NMR and vapor pressure osmometry. For instance, the end group concentration (e.g. the initiating or terminating species) and the repeating unit concentration ratio can be measured via NMR, to give the degree of polymerization before branching. The number average molecular weight, Mn before branching can be calculated by suitable means, including NMR. By comparing the actual Mn value from a direct measurement, such as by vapor pressure osmometry techniques, the degree of branching can be calculated.

Since the polymer has a high molecular weight, relatively low levels of the polymer are required in order to reduce nozzle spitting, improve spray visibility on the applied surface, and to improve spray particle size distribution. Hence, the polymer can present at a level of from 0.0001% to 0.1%, preferably from 0.0005% to 0.010%, more preferably from 0.001% to 0.005% by weight of the composition.

Preferably, the polymer is water-soluble, having a solubility of greater than 1.0 wt % in water at a temperature of 20° C.

### Organic Solvent

The composition can comprise am organic solvent. Preferred solvents include those selected from the group consisting of: aminoalcohols, glycol ether solvents, and mixtures thereof. A blend of solvents comprising an aminoalcohol and a glycol ether solvent is particularly preferred. The surfactant system and aminoalcohol solvent are present at a weight ratio of from 2:1 to 1:10, preferably from 1.5:1 to 1:5, preferably from 1:1 to 1:3.

The composition may comprise organic solvent at a level of from 0.5 to 10%, or from 0.85 to 5.0%, or from 1.15 to 3.0%.

The aminoalcohols can be selected from the group consisting of: monoethanolamine (MEA), triethanolamine, monoisopropanolamine, and mixtures thereof, preferably the aminoalcohol is selected from the group consisting of: monoethanolamine, triethanolamine, and mixtures thereof, more preferably the aminoalcohol is a mixture of monoethanolamine and triethanolamine. The aminoalcohol can be present at a level of from 0.5% to 5.0%, more preferably from 0.75% to 3.5%, most preferably from 0.9% to 2.0% by weight of the composition.

Preferably, the monoethanolamine and triethanolamine are present in a weight ratio of from 0.5:1 to 1:10, preferably from 1:1 to 1:6, more preferably from 1:2 to 1:4, in order to provide improved grease removal.

The detergent composition can comprise a glycol ether solvent. The glycol ether can be selected from Formula 1 or Formula 2.

RiO(R₂O)ₙR₃ Formula 1:
wherein:
R₁ is a linear or branched C₄, C₅ or C₆ alkyl, a substituted or unsubstituted phenyl, preferably n-butyl. Benzyl is one of the substituted phenyls for use herein.
R₂ is ethyl or isopropyl, preferably isopropyl
R₃ is hydrogen or methyl, preferably hydrogen
n is 1, 2 or 3, preferably 1 or 2.

R₄O(R₅O)ₘR₆ Formula 2:
wherein:
R₄ is n-propyl or isopropyl, preferably n-propyl
R₅ is isopropyl
R₆ is hydrogen or methyl, preferably hydrogen
m is 1, 2 or 3 preferably 1 or 2.

Preferred glycol ether solvents according to Formula 1 are ethyleneglycol n-butyl ether, diethyleneglycol n-butyl ether, triethyleneglycol n-butyl ether, propyleneglycol n-butyl ether, dipropyleneglycol n-butyl ether, tripropyleneglycol n-butyl ether, and mixtures thereof.

Most preferred glycol ethers according to Formula 1 are propyleneglycol n-butyl ether, dipropyleneglycol n-butyl ether, and mixtures thereof.

Preferred glycol ether solvents according to Formula 2 are propyleneglycol n-propyl ether, dipropyleneglycol n-propyl ether, and mixtures thereof.

Most preferred glycol ether solvents are propyleneglycol n-butyl ether, dipropyleneglycol n-butyl ether, and mixtures thereof, especially dipropyleneglycol n-butyl ether.

Suitable glycol ether solvents can be purchased from The Dow Chemical Company, more particularly from the E-series (ethylene glycol based) Glycol Ethers and the P-series (propylene glycol based) Glycol Ethers line-ups. Suitable glycol ether solvents include Butyl Carbitol, Hexyl Carbitol, Butyl Cellosolve, Hexyl Cellosolve, Butoxytriglycol, Dowanol Eph, Dowanol PnP, Dowanol DPnP, Dowanol PnB, Dowanol DPnB, Dowanol TPnB, Dowanol PPh, and mixtures thereof.

The glycol ether solvent can be present at a level of 0.05% to 2.0%, preferably from 0.1% to 1.0%, more preferably from 0.25% to 0.75% by weight of the composition. Higher levels of glycol ether solvent have been found to result in reduced surface shine for the treated surface.

The aminoalcohol and glycol ether solvent are present at a weight ratio of from 10:1 to 1:1, preferably 7:1 to 1:2, more preferably from 5:1 to 3:1.

Suitable additional solvents can be selected from the group consisting of: aromatic alcohols; alkoxylated aliphatic alcohols; aliphatic alcohols; C₈-C₁₄ alkyl and cycloalkyl hydrocarbons and halohydrocarbons; terpenes; and mixtures thereof.

### Chelating Agents

The composition may comprise a chelating agent or mixtures thereof. Chelating agents can be incorporated in the compositions herein in amounts ranging from 0.0% to 10.0% by weight of the total composition, preferably 0.01% to 5.0%.

Suitable phosphonate chelating agents for use herein may include alkali metal ethane 1-hydroxy diphosphonates (HEDP), alkylene poly (alkylene phosphonate), as well as amino phosphonate compounds, including aminotri(methylene phosphonic acid) (ATMP), nitrilo trimethylene phosphonates (NTP), ethylene diamine tetra methylene phosphonates, and diethylene triamine penta methylene phosphonates (DTPMP). The phosphonate compounds may be present either in their acid form or as salts of different cations on some or all of their acid functionalities. Preferred phosphonate chelating agents to be used herein are diethylene triamine penta methylene phosphonate (DTPMP) and ethane 1-hydroxy diphosphonate (HEDP). Such phosphonate chelating agents are commercially available from Monsanto under the trade name DEQUEST®.

Polyfunctionally-substituted aromatic chelating agents may also be useful in the compositions herein. See U.S. Pat. No. 3,812,044, issued May 21, 1974, to Connor et al. Preferred compounds of this type in acid form are dihydroxydisulfobenzenes such as 1,2-dihydroxy-3,5-disulfobenzene.

A preferred biodegradable chelating agent for use herein is ethylene diamine N, N′-disuccinic acid, or alkali metal, or alkaline earth, ammonium or substitutes ammonium salts thereof or mixtures thereof. Ethylenediamine N, N′-disuccinic acids, especially the (S, S) isomer have been extensively described in U.S. Pat. No. 4,704,233, Nov. 3, 1987, to Hartman and Perkins. Ethylenediamine N, N′-disuccinic acids is, for instance, commercially available under the tradename ssEDDS® from Palmer Research Laboratories.

Suitable amino carboxylates for use herein include ethylene diamine tetra acetates, diethylene triamine pentaacetates, diethylene triamine pentaacetate (DTPA), N-hydroxyethylethylenediamine triacetates, nitrilotri-acetates, ethylenediamine tetrapropionates, triethylenetetraaminehexa-acetates, ethanol-diglycines, propylene diamine tetracetic acid (PDTA) and methyl glycine diacetic acid (MGDA), both in their acid form, or in their alkali metal, ammonium, and substituted ammonium salt forms. Particularly suitable amino carboxylates to be used herein are diethylene triamine penta acetic acid, propylene diamine tetracetic acid (PDTA) which is, for instance, commercially available from BASF under the trade name Trilon FS® and methyl glycine di-acetic acid (MGDA). Further carboxylate chelating agents for use herein include salicylic acid, aspartic acid, glutamic acid, glycine, malonic acid or mixtures thereof.

### Other Ingredients

The composition may further include any suitable ingredients such as builders, other polymers, preservative, hydrotropes, stabilisers, radical scavengers, bleaches, bleaches activators, soil suspenders, dispersant, silicones, fatty acid, branched fatty alcohol, and/or dye.

### The Plurality of Spray Droplets:

The spray comprises a plurality of droplets of a hard surface cleaning composition, wherein spray droplets have a particle size distribution such that the Dv10 is at least 50 microns and the ratio of Dv90 to Dv10 is less than 6.4.

The spray droplets have a particle size distribution such that the Dv10 is at least 50 microns, preferably greater than 60 microns. Limiting the fraction of smaller particles further reduces over-spray since smaller droplets have a greater tendency to be carried away by the spray turbulence, and hence are less likely to contact the surface to be treated. In addition, such fine droplets are more likely to be inhaled and cause nasal and throat irritation.

Nasal and throat irritation can be further reduced by limiting the particle size distribution such that the volume percent of spray particles in the range of from 10 microns to 100 microns is at most 25%, preferably at most 20%, more preferably at most 15%.

A greater uniformity of droplets provides improved spray uniformity and greater visibility during spraying. Hence, the ratio of Dv90 to Dv10 is less than 6.4, preferably less than 6.0, more preferably from 4.0 to 6.0, most preferably from 5.0 to 5.5.

The Dv90 is preferably less than 375 microns, preferably less than 325 microns, more preferably less than 300 microns. By limiting the larger sized droplets, a more uniform distribution of the detersive composition on the surface to be treated is achieved. As a result, less wiping is needed in order to clean the surface. Larger spray droplets are more likely to coalesce at the nozzle to cause nozzle-spitting and also not reach the surface to be treated when the hard surface is inclined, especially when the surface is a vertical surface such a wall. Moreover, less dripping on inclined surfaces is achieved, even at lower thickener levels.

A greater uniformity of droplets provides improved spray uniformity and greater visibility during spraying. Hence, reducing the fraction of fine droplets is preferably done without skewing the distribution of droplet sizes to larger particle sizes. As such, the spray droplets can have a particle size distribution such that the ratio of Dv90 to Dv10 is less than 7.0, preferably from 3.0 to less than 7.0, more preferably from 3.5 to less than 6.0, and most preferably from 4.0 to 5.0. Spray uniformity can also be improved limiting the shift in the mean particle size as the fraction of fine droplets is reduced. As such, the spray droplets can have a particle size distribution such that the ratio of Dv4.3 to Dv10 is less than 3.5, preferably from 2.1 to less than 3.5, more preferably from 2.4 to less than 3.3, and most preferably from 2.6 to less than 2.9.

In examples, the composition 208 may be a liquid hand dishwashing spray composition.

### Liquid Hand Dishwashing Spray Compositions:

The liquid spray cleaning composition typically comprises an aqueous carrier in which all the other composition actives are dissolved or eventually dispersed. As such, water can be present in an amount of from 60% to 90%, preferably from 75% to 85% by weight of the composition.

Preferably the pH of the liquid hand dishwashing spray composition is greater than 8, more preferably from about 10 to about 12 and most preferably from about 10.5 to about 11.5, as measured at 20° C. on the neat product composition. Preferably, the liquid hand dishwashing spray composition has a reserve alkalinity of from about 0.1 to about 1, more preferably from about 0.1 to about 0.5 measured as detailed herein below.

Reserve alkalinity is defined as the grams of NaOH per 100 g of composition required to titrate the test composition at pH 10 to come to the test composition pH. The reserve alkalinity for a solution is determined in the following manner.

A pH meter (for example An Orion Model 720A) with a Ag/AgCl electrode (for example an Orion sure flow Electrode model 9172BN) is calibrated using standardized pH 7 and pH 10 buffers. A 100 g of a 10% solution in distilled water at 20° C. of the composition to be tested is prepared. The pH of the 10% solution is measured and the 100 g solution is titrated down to pH 10 using a standardized solution of 0.1 N of HCl. The volume of 0.1N HCl required is recorded in ml. The reserve alkalinity is calculated as follows:

Reserve Alkalinity=ml 0.1N HCl×0.1 (equivalent/liter)×Equivalent weight NaOH (g/equivalent)×10.

The liquid hand dishwashing spray cleaning product according to the present disclosure can comprise a composition having a Newtonian viscosity, such as from 1 mPa·s to 50 mPa·s, preferably from 1 mPa·s to 20 mPa·s, more preferably from 1 mPa·s to 10 mPa·s, at 20° C. as measured using the method defined herein. Alternatively the cleaning product according to the present disclosure can comprise a composition having a shear thinning rheology profile, such as having a high shear viscosity of from 1 mPa·s to 50 mPa·s, preferably from 1 mPa·s to 20 mPa·s, more preferably from 5 mPa·s to 15 mPa·s, when measured at a shear rate of at 1000 s⁻¹ at 20° C., and a low shear viscosity of from 100 mPa·s to 1,000 mPa·s, preferably from 200 mPa·s to 500 mPa·s, when measured at 0.1 s⁻¹ at 20° C., using the method defined herein. Preferably the cleaning composition of use in the present disclosure has a Newtonian viscosity. The method for determining viscosity is provided hereafter.

It is worth noting that where the liquid composition is a hand dishwashing liquid composition, the viscosity can be greater than where the liquid composition is a liquid hand dishwashing spray composition. The liquid compositions of the present disclosure may comprise a viscosity of from about 1 mPa·s to about 10,000 mPa·s, preferably from about 100 mPa·s to about 5,000 mPa·s, more preferably from 300 mPa·s to about 2,000 mPa·s, or most preferably from about 500 mPa·s to about 1,500 mPa·s, specifically including all values within these ranges and any ranges created thereby. However, it is believed that higher Newtonian viscosities, e.g., greater than 50 mPa·s, in a sprayer would make the liquid compositions overly difficult to dispense by a user. In contrast, users typically desire hand dishwashing liquid compositions to have a higher viscosity such that the liquid “sticks” to some extent on the surfaces to which the liquid composition is applied. Accordingly, the viscosities of the liquid compositions described herein may have the viscosities described herein depending on their application.

### Surfactant System

The liquid hand dishwashing spray composition comprises from 2% to 25%, preferably from 5% to 20%, more preferably from 8% to 15% by weight thereof of a surfactant system. The surfactant system may comprise an alkyl sulphate or an alkyl ethoxylated sulfate anionic surfactant, a co-surfactant preferably selected from the group consisting of amphoteric surfactants, zwitterionic surfactants, and mixtures thereof, and optionally a non-ionic surfactant. Alternatively, the surfactant system may comprise a non-ionic surfactant preferably an alkyl polyglucoside non-ionic surfactant, and a co-surfactant preferably selected from the group consisting of amphoteric surfactants, zwitterionic surfactants, and mixtures thereof, wherein the composition preferably comprises less than 3% by weight of the composition more preferably is free of anionic surfactant. Preferably, the co-surfactant is an amphoteric surfactant wherein the amphoteric co-surfactant is an amine oxide co-surfactant.

Preferably, the anionic alkyl sulfate or alkyl ethoxylated sulfate surfactant, or the alkyl polyglucoside surfactant, and the co-surfactant are present in the composition of the invention in a weight ratio of 10:1 to 1:2 preferably from 5:1 to 1:1.5 most preferably from 3:1 to 1:1.

When formulating an anionic surfactant alkyl ethoxy sulfates with an average degree of ethoxylation from about 2 to about 5, most preferably about 3 are preferred for use herein.

### Alkyl Sulfated Anionic Surfactant

A preferred sulfated anionic surfactant is an alkoxylate, more preferably, an alkoxylate sulfate anionic surfactant. Preferably, the alkoxy group is ethoxy. Alkyl sulphated anionic surfactants are preferred, particularly those selected from the group consisting of: alkyl sulphate, alkyl alkoxy sulphate preferably alkyl ethoxy sulphate, and mixtures thereof. The alkyl sulphated anionic surfactant preferably has an average alkyl chain length of from 8 to 18, preferably from 10 to 14, more preferably from 12 to 14, most preferably from 12 to 13 carbon atoms. The alkyl sulphated anionic surfactant preferably has an average degree of alkoxylation preferably ethoxylation, of less than or equal to 5, preferably from 2 to 5, most preferably about 3. The alkyl sulphate anionic surfactant preferably has a weight average degree of branching of more than 10%, preferably more than 20%, more preferably more than 30%, even more preferably between 30% and 60%, most preferably between 30% and 50%. Suitable counterions include alkali metal cation earth alkali metal cation, alkanolammonium or ammonium or substituted ammonium, but preferably sodium. Suitable examples of commercially available alkyl sulphate anionic surfactants include, those derived from alcohols sold under the Neodol® brand-name by Shell, or the Lial®, Isalchem®, and Safol® brand-names by Sasol, or some of the natural alcohols produced by The Procter & Gamble Chemicals company.

### Alkyl Polyglucoside Surfactant:

The surfactant system preferably comprises the alkyl polyglucoside (“APG”) at a level of from 2.0% to 12%, preferably from 2.5% to 10%, more preferably from 3.0% to 7.5% by weight of the composition. For improved crystalline grease removal, the alkyl polyglucoside surfactant can have a number average alkyl carbon chain length between 8 and 18, preferably between 10 and 16, most preferably between 12 and 14, with an average degree of polymerization of between 0.1 and 3.0 preferably between 1.0 and 2.0, most preferably between 1.2 and 1.6. For improved initial sudsing, the alkyl polyglucoside surfactant can have a number average alkyl carbon chain length between 8 and 18, preferably between 8 and 14, most preferably between 8 and 10, with an average degree of polymerization of between 0.1 and 3.0 preferably between 1.0 and 2.0, most preferably between 1.2 and 1.6. C8-C18 alkyl polyglucosides are commercially available from several suppliers (e.g., Simusol® surfactants from Seppic Corporation; and Glucopon® 600 CSUP, Glucopon® 650 EC, Glucopon® 600 CSUP/MB, and Glucopon® 650 EC/MB, from BASF Corporation).

### Amphoteric Surfactant

Preferably the amphoteric surfactant is an amine oxide. Preferred amine oxides are alkyl dimethyl amine oxide or alkyl amido propyl dimethyl amine oxide, more preferably alkyl dimethyl amine oxide and especially coco dimethyl amino oxide or the C12-C14 alkyl fraction thereof.

Amine oxide may have a linear or mid-branched alkyl moiety. Typical linear amine oxides include water-soluble amine oxides containing one R1 C8-18 alkyl moiety and 2 R2 and R3 moieties selected from the group consisting of C1-3 alkyl groups and C1-3 hydroxyalkyl groups. Preferably amine oxide is characterized by the formula R1-N(R2)(R3)O wherein R1 is a C8-18 alkyl and R2 and R3 are selected from the group consisting of methyl, ethyl, propyl, isopropyl, 2-hydroxethyl, 2-hydroxypropyl and 3-hydroxypropyl. The linear amine oxide surfactants in particular may include linear C10-C18 alkyl dimethyl amine oxides and linear C8-C12 alkoxy ethyl dihydroxy ethyl amine oxides. Preferred amine oxides include linear C10, linear C10-C12, and linear C12-C14 alkyl dimethyl amine oxides. As used herein “mid-branched” means that the amine oxide has one alkyl moiety having n1 carbon atoms with one alkyl branch on the alkyl moiety having n2 carbon atoms. The alkyl branch is located on the a carbon from the nitrogen on the alkyl moiety. This type of branching for the amine oxide is also known in the art as an internal amine oxide. The total sum of n1 and n2 is from 10 to 24 carbon atoms, preferably from 12 to 20, and more preferably from 10 to 16. The number of carbon atoms for the one alkyl moiety (n1) should be approximately the same number of carbon atoms as the one alkyl branch (n2) such that the one alkyl moiety and the one alkyl branch are symmetric. As used herein “symmetric” means that |n1−n2| is less than or equal to 5, preferably 4, most preferably from 0 to 4 carbon atoms in at least 50 wt %, more preferably at least 75 wt % to 100 wt % of the mid-branched amine oxides for use herein.

The amine oxide further comprises two moieties, independently selected from a C1-3 alkyl, a C1-3 hydroxyalkyl group, or a polyethylene oxide group containing an average of from about 1 to about 3 ethylene oxide groups. Preferably the two moieties are selected from a C1-3 alkyl, more preferably both are selected as a C1 alkyl.

### Zwitterionic Surfactant

Other suitable surfactants include zwitterionic surfactants, preferably betaines, such as alkyl betaines, alkylamidobetaine, amidazoliniumbetaine, sulfobetaine (INCI Sultaines) as well as the Phosphobetaine and preferably meets formula (I):

R1-[CO—X(CH2)n]x-N+(R2)(R3)-(CH2)m-[CH(OH)—CH2]y-Y— (I)
wherein R1 is a saturated or unsaturated C6-22 alkyl residue, preferably C8-18 alkyl residue, in particular a saturated C10-16 alkyl residue, for example a saturated C12-14 alkyl residue; X is NH, NR4 with C1-4 Alkyl residue R4, O or S; n a number from 1 to 10, preferably 2 to 5, in particular 3; x is 0 or 1, preferably 1; R2, R3 are independently a C1-4 alkyl residue, potentially hydroxy substituted such as a hydroxyethyl, preferably a methyl; m a number from 1 to 4, in particular 1, 2 or 3; y is 0 or 1 and Y is COO, SO3, OPO(OR5)O or P(O)(OR5)O, whereby R5 is a hydrogen atom H or a C1-4 alkyl residue.

Preferred betaines are the alkyl betaines of the formula (Ia), the alkyl amido propyl betaine of the formula (Ib), the Sulfo betaines of the formula (Ic) and the Amido sulfobetaine of the formula (Id);

R1-N+(CH3)2-CH2COO— (Ia)

R1-CO—NH(CH2)3-N+(CH3)2-CH2COO— (Ib)

R1-N+(CH3)2-CH2CH(OH)CH2SO3- (Ic)

R1-CO—NH—(CH2)3-N+(CH3)2-CH2CH(OH)CH2SO3- (Id)

in which R1 has the same meaning as in formula I.

Particularly preferred betaines are the Carbobetaine [wherein Y—═COO—], in particular the Carbobetaine of the formula (Ia) and (Ib), more preferred are the Alkylamidobetaine of the formula (Ib). Examples of suitable betaines and sulfobetaine are the following [designated in accordance with INCI]: Almondamidopropyl of betaines, Apricotam idopropyl betaines, Avocadamidopropyl of betaines, Babassuamidopropyl of betaines, Behenam idopropyl betaines, Behenyl of betaines, betaines, Canolam idopropyl betaines, Capryl/Capram idopropyl betaines, Carnitine, Cetyl of betaines, Cocamidoethyl of betaines, Cocam idopropyl betaines, Cocam idopropyl Hydroxysultaine, Coco betaines, Coco Hydroxysultaine, Coco/Oleam idopropyl betaines, Coco Sultaine, Decyl of betaines, Dihydroxyethyl Oleyl Glycinate, Dihydroxyethyl Soy Glycinate, Dihydroxyethyl Stearyl Glycinate, Dihydroxyethyl Tallow Glycinate, Dimethicone Propyl of PG-betaines, Erucam idopropyl Hydroxysultaine, Hydrogenated Tallow of betaines, Isostearam idopropyl betaines, Lauram idopropyl betaines, Lauryl of betaines, Lauryl Hydroxysultaine, Lauryl Sultaine, MilIkam idopropyl betaines, Minkamidopropyl of betaines, Myristam idopropyl betaines, Myristyl of betaines, Oleam idopropyl betaines, Oleam idopropyl Hydroxysultaine, Oleyl of betaines, Olivamidopropyl of betaines, Palmam idopropyl betaines, Palm itam idopropyl betaines, Palmitoyl Carnitine, Palm Kernelam idopropyl betaines, Polytetrafluoroethylene Acetoxypropyl of betaines, Ricinoleam idopropyl betaines, Sesam idopropyl betaines, Soyam idopropyl betaines, Stearam idopropyl betaines, Stearyl of betaines, Tallowam idopropyl betaines, Tallowam idopropyl Hydroxysultaine, Tallow of betaines, Tallow Dihydroxyethyl of betaines, Undecylenam idopropyl betaines and Wheat Germam idopropyl betaines.

A preferred betaine is, for example, cocoamidopropylbetaine.

### Further Non-Ionic Surfactant:

The surfactant system can comprise further non-ionic surfactant. If present, the surfactant system can comprise from 0.5% to 10%, preferably from 1.0% to 5.0%, more preferably from 1.5% to 3.0% by weight of the composition of the further nonionic surfactant.

Suitable further non-ionic surfactants include alkyl alkoxylated non-ionic surfactants, more preferably ethoxylated non-ionic surfactants. Suitable nonionic surfactants include the condensation products of aliphatic alcohols with from 1 to 25 moles of ethylene oxide. The alkyl chain of the aliphatic alcohol can either be straight or branched, primary or secondary, preferably straight.

The further nonionic surfactant is preferably a low-cut alkyl ethoxylate surfactant. Low cut alcohol ethoxylate surfactants include alcohol ethoxylate surfactants with an average alkyl carbon chain length of C10 and below. More preferably the alkyl ethoxylate surfactant has an average alkyl chain length of between C5 to C8, preferably between C5 to C7, and a number average degree of ethoxylation of from 1 to 10, preferably from 3 to 8, more preferably from 4 to 6. Suitable non-ionic alcohol ethoxylate surfactants include commercially available materials such as Emulan® HE50 or Lutensol® CS6250 (available from BASF).

Other suitable non-ionic surfactants for use herein can be selected from fatty alcohol polyglycol ethers, fatty acid glucamides, and mixtures thereof.

A preferred surfactant system for the detergent composition of the present invention comprises preferably consists of: (1) 4% to 10%, preferably 5% to 8% by weight of the composition of an alkyl ethoxylated sulfate anionic surfactant; (2) 1% to 5%, preferably from 1% to 4% by weight of the composition of a surfactant selected from the group consisting of amphoteric surfactant, zwitterionic surfactant and mixtures thereof, preferably an amine oxide co-surfactant, and (3) from 1.5% to 6.0% of a low cut alcohol ethoxylate nonionic surfactant, preferably having an average alkyl chain length of between C5 and C7 and a number average degree of ethoxylation of from 4 to 6.

Another preferred surfactant system comprises preferably consists of i) from 3.0 to 7.5% of an alkyl polyglucoside surfactant, preferably having an average alkyl chain length between 12 and 14 and an average degree of polymerization of between 1.2 and 1.6, ii) 2.0 to 4.0% of an amine oxide surfactant, preferably a C12-C14 dimethyl amine oxide surfactant, and iii) from 1.5% to 6.0% of a low cut alcohol ethoxylate nonionic surfactant, preferably having an average alkyl chain length of between C5 and C7 and a number average degree of ethoxylation of from 4 to 6. Such surfactant systems in combination with the glycol ethers described below can provide excellent cleaning and good foaming profile.

The liquid spray detergent composition could optionally comprise a cationic surfactant, preferably a quaternary ammonium type cationic surfactant.

### Glycol Ether Solvent

The composition of the invention preferably comprises a glycol ether solvent selected from glycol ethers of Formula I or Formula II.

R1O(R2O)nR3 Formula I:
Wherein R1 is a linear or branched C4, C5 or C6 alkyl, a substituted or unsubstituted phenyl, preferably n-butyl. Benzyl is one of the substituted phenyls for use herein; R2 is ethyl or isopropyl, preferably isopropyl; R3 is hydrogen or methyl, preferably hydrogen; n is 1, 2 or 3, preferably 1 or 2.

R4O(R5O)nR6 Formula II:
Wherein R4 is n-propyl or isopropyl, preferably n-propyl; R5 is isopropyl; R6 is hydrogen or methyl, preferably hydrogen; n is 1, 2 or 3 preferably 1 or 2.

Suitable glycol ether solvents according to Formula I include ethyleneglycol n-butyl ether, diethyleneglycol n-butyl ether, triethyleneglycol n-butyl ether, propyleneglycol n-butyl ether, dipropyleneglycol n-butyl ether, tripropyleneglycol n-butyl ether, ethyleneglycol n-pentyl ether, diethyleneglycol n-pentyl ether, triethyleneglycol n-pentyl ether, propyleneglycol n-pentyl ether, dipropyleneglycol n-pentyl ether, tripropyleneglycol n-pentyl ether, ethyleneglycol n-hexyl ether, diethyleneglycol n-hexyl ether, triethyleneglycol n-hexyl ether, propyleneglycol n-hexyl ether, dipropyleneglycol n-hexyl ether, tripropyleneglycol n-hexyl ether, ethyleneglycol phenyl ether, diethyleneglycol phenyl ether, triethyleneglycol phenyl ether, propyleneglycol phenyl ether, dipropyleneglycol phenyl ether, tripropyleneglycol phenyl ether, ethyleneglycol benzyl ether, diethyleneglycol benzyl ether, triethyleneglycol benzyl ether, propyleneglycol benzyl ether, dipropyleneglycol benzyl ether, tripropyleneglycol benzyl ether, ethyleneglycol isobutyl ether, diethyleneglycol isobutyl ether, triethyleneglycol isobutyl ether, propyleneglycol isobutyl ether, dipropyleneglycol isobutyl ether, tripropyleneglycol isobutyl ether, ethyleneglycol isopentyl ether, diethyleneglycol isopentyl ether, triethyleneglycol isopentyl ether, propyleneglycol isopentyl ether, dipropyleneglycol isopentyl ether, tripropyleneglycol isopentyl ether, ethyleneglycol isohexyl ether, diethyleneglycol isohexyl ether, triethyleneglycol isohexyl ether, propyleneglycol isohexyl ether, dipropyleneglycol isohexyl ether, tripropyleneglycol isohexyl ether, ethyleneglycol n-butyl methyl ether, diethyleneglycol n-butyl methyl ether triethyleneglycol n-butyl methyl ether, propyleneglycol n-butyl methyl ether, dipropyleneglycol n-butyl methyl ether, tripropyleneglycol n-butyl methyl ether, ethyleneglycol n-pentyl methyl ether, diethyleneglycol n-pentyl methyl ether, triethyleneglycol n-pentyl methyl ether, propyleneglycol n-pentyl methyl ether, dipropyleneglycol n-pentyl methyl ether, tripropyleneglycol n-pentyl methyl ether, ethyleneglycol n-hexyl methyl ether, diethyleneglycol n-hexyl methyl ether, triethyleneglycol n-hexyl methyl ether, propyleneglycol n-hexyl methyl ether, dipropyleneglycol n-hexyl methyl ether, tripropyleneglycol n-hexyl methyl ether, ethyleneglycol phenyl methyl ether, diethyleneglycol phenyl methyl ether, triethyleneglycol phenyl methyl ether, propyleneglycol phenyl methyl ether, dipropyleneglycol phenyl methyl ether, tripropyleneglycol phenyl methyl ether, ethyleneglycol benzyl methyl ether, diethyleneglycol benzyl methyl ether, triethyleneglycol benzyl methyl ether, propyleneglycol benzyl methyl ether, dipropyleneglycol benzyl methyl ether, tripropyleneglycol benzyl methyl ether, ethyleneglycol isobutyl methyl ether, diethyleneglycol isobutyl methyl ether, triethyleneglycol isobutyl methyl ether, propyleneglycol isobutyl methyl ether, dipropyleneglycol isobutyl methyl ether, tripropyleneglycol isobutyl methyl ether, ethyleneglycol isopentyl methyl ether, diethyleneglycol isopentyl methyl ether, triethyleneglycol isopentyl methyl ether, propyleneglycol isopentyl methyl ether, dipropyleneglycol isopentyl methyl ether, tripropyleneglycol isopentyl methyl ether, ethyleneglycol isohexyl methyl ether, diethyleneglycol isohexyl methyl ether, triethyleneglycol isohexyl methyl ether, propyleneglycol isohexyl methyl ether, dipropyleneglycol isohexyl methyl ether, tripropyleneglycol isohexyl methyl ether, and mixtures thereof.

Preferred glycol ether solvents according to Formula I are ethyleneglycol n-butyl ether, diethyleneglycol n-butyl ether, triethyleneglycol n-butyl ether, propyleneglycol n-butyl ether, dipropyleneglycol n-butyl ether, tripropyleneglycol n-butyl ether, and mixtures thereof.

Most preferred glycol ethers according to Formula I are propyleneglycol n-butyl ether, dipropyleneglycol n-butyl ether, and mixtures thereof.

Suitable glycol ether solvents according to Formula II include propyleneglycol n-propyl ether, dipropyleneglycol n-propyl ether, tripropyleneglycol n-propyl ether, propyleneglycol isopropyl ether, dipropyleneglycol isopropyl ether, tripropyleneglycol isopropyl ether, propyleneglycol n-propyl methyl ether, dipropyleneglycol n-propyl methyl ether, tripropyleneglycol n-propyl methyl ether, propyleneglycol isopropyl methyl ether, dipropyleneglycol isopropyl methyl ether, tripropyleneglycol isopropyl methyl ether, and mixtures thereof.

Preferred glycol ether solvents according to Formula II are propyleneglycol n-propyl ether, dipropyleneglycol n-propyl ether, and mixtures thereof.

Most preferred glycol ether solvents are propyleneglycol n-butyl ether, dipropyleneglycol n-butyl ether, and mixtures thereof, especially dipropyleneglycol n-butyl ether.

Suitable glycol ether solvents can be purchased from The Dow Chemical Company, more particularly from the E-series (ethylene glycol based) Glycol Ethers and the P-series (propylene glycol based) Glycol Ethers line-ups. Suitable glycol ether solvents include Butyl Carbitol, Hexyl Carbitol, Butyl Cellosolve, Hexyl Cellosolve, Butoxytriglycol, Dowanol Eph, Dowanol PnP, Dowanol DPnP, Dowanol PnB, Dowanol DPnB, Dowanol TPnB, Dowanol PPh, and mixtures thereof.

The glycol ether of the product of the invention can boost foaming. The glycol ether solvent typically is present from about 1% to about 10%, preferably from about 2 to about 8%, most preferably from about 3% to about 7% by weight of the composition. Preferably the surfactant system and the glycol ether system are present in a relative weight ratio of from 5:1 to 1:5, preferably from 3:1 to 1:3.

### Further Optional Ingredients

The composition herein may comprise a number of optional ingredients such as chelants such as aminocarboxylate or aminophosphonate chelants preferably GLDA, builders preferably carboxylate builders such as citric acid, rheology trimming agents selected from inorganic salts preferably sodium chloride, C2-C4 alcohols, C2-C4 polyols, poly alkylene glycols, hydrotropes, and mixtures thereof. Alternatively, the composition may include a shear thinning rheology modified, preferably xanthan gum. The composition might also comprise pH trimming and/or buffering agents such as sodium hydroxyde, alkanolamines including monoethanolamine, and bicarbonate inorganic salts. The composition might comprise further minor ingredients selected from preservatives, UV stabilizers, antioxidants, perfumes, coloring agents and mixtures thereof. The composition comprises less than 10 ppm preferably less than 1 ppm of dioxane, alternatively is free of dioxane, especially 1,4-dioxane.

The composition may comprise traces of packaging additives such as plasticizers that may have migrated from the spray packaging into the liquid detergent composition upon ageing of the product. Similarly traces of components of the liquid detergent composition such as solvents or perfume may have migrated into the spray packaging material.

TABLE 1
Liquid hand dishwashing spray detergent compositions

| As 100% active | Ex 7 | Ex 8 | Ex 9 | Ex 10 | Ex 11 |
|---|---|---|---|---|---|
| C12 to C14 APG (Glucopon ® 600) | 6.54 | — | 6.54 | — | — |
| C8 to C10 APG (Glucopon ® 215) | — | 6.54 | — | — | — |
| C12-14AE3S anionic surfactant | — | — | — | 6.54 | 6.54 |
| C12-14 dimethylamine oxide | 2.46 | 2.46 | — | 2.46 | — |
| Cocoamidopropyl betaine | — | — | 2.46 | — | 2.46 |
| C6EO5 nonionic surfactant (Lutensol | 5.00 | 4.00 | 6.00 | 5.00 | 4.00 |
| CS6250) | | | | | |
| Monoethanolamine | 0.50 | 0.50 | 0.50 | 0.50 | 0.50 |
| GLDA chelant | 1.00 | 0.75 | 0.50 | 1.00 | 1.00 |
| Citric acid | 0.12 | 0.12 | 0.12 | 0.12 | 0.12 |
| PPG (MW 2000) | 0.05 | 0.05 | 0.05 | 0.05 | 0.05 |
| ethanol | 0.34 | 0.34 | 0.34 | 0.34 | 0.34 |
| Dowanol DPnB glycol ether solvent | 5.00 | 4.00 | 6.00 | 5.00 | 5.00 |
| phenoxyethanol | 0.30 | 0.30 | 0.30 | 0.30 | 0.30 |
| perfume | 0.35 | 0.35 | 0.35 | 0.35 | 0.35 |
| Water and optional dyes | Balance | Balance | Balance | Balance | Balance |
| | to 100 | to 100 | to 100 | to 100 | to 100 |
| pH (neat) | 11.0 | 11.5 | 8.5 | 11.0 | 9.0 |

The presently described subject matter may include one or more aspects, which should not be regarded as limiting on the teaching of the present disclosure. A first aspect may include a spray dispenser container comprising: a housing comprising a first end portion, a second end portion, a sidewall extending between the first end portion and the second end portion, and a cavity at least partially surrounded by the sidewall; a pump assembly in fluid communication with a replaceable composition container comprising a composition, the pump assembly being disposed within the cavity; an actuator in operative communication with the pump assembly; a nozzle in fluid communication with the pump assembly; and a motor in operative communication with the actuator, wherein: when the spray dispenser container is rotated 360° along the vertical plane, the pump assembly maintains fluid communication with the replaceable composition container such that the composition can be dispensed throughout the 360° rotation.

A second aspect may include a replaceable fluid composition container comprising: a sidewall comprising a flexible inner liner wherein the sidewall partially surrounds a reservoir comprising a composition; a puncturable cap connected to the sidewall, wherein: the puncturable cap comprises a frangible seal.

Another aspect may include any of the previous aspects, further comprising a valve assembly.

Another aspect may include any of the previous aspects, further comprising a flow path from the replaceable composition container through the pump assembly to the nozzle.

Another aspect may include any of the previous aspects, wherein the pump comprises a variable pressure diaphragm pump.

Another aspect may include any of the previous aspects, wherein the pump comprises a variable pressure gear pump.

Another aspect may include any of the previous aspects, further comprising a microprocessor.

Another aspect may include any of the previous aspects, further comprising a battery.

Another aspect may include any of the previous aspects, wherein the battery is rechargeable.

Another aspect may include any of the previous aspects, further comprising a proximity sensor.

Another aspect may include any of the previous aspects, further comprises a proximity light.

Another aspect may include any of the previous aspects, wherein the proximity sensor is communicably coupled to a microprocessor.

Another aspect may include any of the previous aspects, wherein the replaceable composition container comprises an RFID tag.

Another aspect may include any of the previous aspects, wherein the microprocessor reads the RFID tag and changes the distance required by the proximity sensor.

Another aspect may include any of the previous aspects, comprising a motion sensor.

Another aspect may include any of the previous aspects, wherein the motion sensor differentiates between waving the dispenser or pointing the dispenser.

Another aspect may include any of the previous aspects, wherein the replaceable composition container comprises fiber-based material.

Another aspect may include any of the previous aspects, wherein the replaceable composition container comprises a volatile composition.

Another aspect may include any of the previous aspects, wherein the replaceable composition container comprises a delaminating bottle.

Another aspect may include any of the previous aspects, wherein the composition is a liquid.

Another aspect may include any of the previous aspects, wherein the spray dispenser dispenses a fine mist through the nozzle.

Another aspect may include any of the previous aspects, wherein a flow rate of the composition exiting the nozzle is from about 0.5 to about 5 ml/s.

Another aspect may include any of the previous aspects, wherein a pressure of the composition in a flow path ranges from 2 to 10 bar.

Another aspect may include any of the previous aspects, wherein the replaceable composition container comprises from 90% to 100% recyclable content.

Another aspect may include any of the previous aspects, wherein the replaceable composition container comprises from about 20 to about 50 wt. % plastic and from about 50 to about 80 wt. % fiber-based material by weight of the replaceable composition container.

Another aspect may include any of the previous aspects, wherein the puncturable cap clicks when activated.

Another aspect may include any of the previous aspects, wherein the replaceable fluid composition container comprises from 90% to 100% recyclable content.

Another aspect may include any of the previous aspects, wherein the replaceable fluid composition container comprises from about 20 to about 50 wt. % plastic and from about 50 to about 80 wt. % fiber-based material by weight of the replaceable fluid composition container.

Another aspect may include any of the previous aspects, wherein the replaceable fluid composition container comprises fiber-based material.

Another aspect may include any of the previous aspects, wherein the replaceable fluid composition container comprises a volatile composition.

Another aspect may include any of the previous aspects, wherein the replaceable fluid composition container comprises a delaminating bottle.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any examples disclosed or claimed herein or that it alone, or in any combination with any other reference or references, teaches, suggests or discloses any such example. Further, to the extent that any meaning or definition of a term in this document conflicts with any meaning or definition of the same term in a document incorporated by reference, the meaning or definition assigned to that term in this document shall govern.

While particular examples of the present composition have been illustrated and described, it would be obvious to those skilled in the art that various other changes and modifications can be made without departing from the spirit and scope of the disclosure. It is therefore intended to cover in the appended claims all such changes and modifications that are within the scope of this disclosure.

What is claimed is:

1. A spray dispenser container comprising:
a housing comprising a first end portion, a second end portion, a sidewall extending between the first end portion and the second end portion, and a cavity at least partially surrounded by the sidewall;
a pump assembly in fluid communication with a replaceable composition container comprising a composition, the pump assembly being disposed within the cavity;
an actuator in operative communication with the pump assembly;
a nozzle in fluid communication with the pump assembly; and
a motor in operative communication with the actuator,
wherein when the spray dispenser container is rotated 360° along the vertical plane, the pump assembly maintains fluid communication with the replaceable composition container such that the composition can be dispensed throughout the 360° rotation.

2. The spray dispenser container of claim 1, further comprising a valve assembly.

3. The spray dispenser container of claim 1, further comprising a flow path from the replaceable composition container through the pump assembly to the nozzle.

4. The spray dispenser container of claim 1, wherein the pump assembly comprises a variable pressure diaphragm pump.

5. The spray dispenser container of claim 1, wherein the pump assembly comprises a variable pressure gear pump.

6. The spray dispenser container of claim 1, further comprising a microprocessor.

7. The spray dispenser container of claim 1, further comprising a battery, wherein the battery is rechargeable.

8. The spray dispenser container of claim 1, further comprising a proximity sensor, wherein the proximity sensor comprises a proximity light.

9. The spray dispenser container of claim 8, wherein the proximity sensor is communicably coupled to a microprocessor and the replaceable composition container comprises an RFID tag, and wherein the microprocessor is configured to read the RFID tag and change a distance required by the proximity sensor.

10. The spray dispenser container of claim 1, comprising a motion sensor, wherein the motion sensor differentiates between waving the dispenser or pointing the dispenser.

11. The spray dispenser container of claim 1, wherein the replaceable composition container comprises from about 20 to about 50 wt. % plastic and from about 50 to about 80 wt. % fiber-based material by weight of the replaceable composition container.

12. The spray dispenser container of claim 1, wherein the composition comprises a liquid volatile composition.

13. The spray dispenser container of claim 1, wherein the replaceable composition container comprises a delaminating bottle.

14. The spray dispenser container of claim 1, wherein the spray dispenser dispenses a fine mist through the nozzle.

15. The spray dispenser container of claim 1, wherein a flow rate of the composition exiting the nozzle is from about 0.5 to about 5 ml/s.

16. The spray dispenser container of claim 1, wherein a pressure of the composition in a flow path ranges from 2 to 10 bar.

17. A replaceable fluid composition container comprising:
a sidewall comprising a flexible inner liner wherein the sidewall partially surrounds a reservoir comprising a composition, wherein the composition comprises a volatile composition; and
a puncturable cap connected to the sidewall, wherein the puncturable cap comprises a frangible seal.

18. The replaceable fluid composition container of claim 17, wherein the puncturable cap clicks when activated.

19. The replaceable fluid composition container of claim 17, wherein the replaceable fluid composition container comprises from about 20 to about 50 wt. % plastic and from about 50 to about 80 wt. % fiber-based material by weight of the replaceable fluid composition container.

20. The replaceable fluid composition container of claim 17, wherein the replaceable fluid composition container comprises a delaminating bottle.
